(19) United States
(12) Patent Application Publication
(10) Pub. No.: US 2026/0179799 A1
(43) Pub. Date: Jun. 25, 2026

(54) RADIATION SHIELDING GARMENT WITH MODULAR BACK PANEL AND EXPANDABLE PORTIONS

(71) Applicant: Salus Scientific Corp., Charleston, SC (US)

(72) Inventors: Nick TOMCZAK, Richlands, NC (US); Benly PHOUTINAN, Charleston, SC (US)

(21) Appl. No.: 19/422,081

(22) Filed: Dec. 16, 2025

Related U.S. Application Data
(60) Provisional application No. 63/734,336, filed on Dec. 16, 2024.

(51) Int. Cl. G21F 3/02; G21F 1/12

(52) U.S. Cl. CPC G21F 3/02; G21F 1/12

(57) ABSTRACT

A radiation shielding apparatus includes a front portion configured to cover a torso of a user. The front portion includes a left front portion and a right front portion. The radiation shielding apparatus includes a back portion connected to the front portion. The back portion includes a plurality of openings arranged in a pattern. The back portion includes at least one expandable portion having a plurality of holes. The back portion includes an expandable mechanism extending through the plurality of holes. The expandable mechanism is configured to expand with pressure applied by the user. The radiation shielding apparatus includes a radiation shielding material arranged within the front portion. The radiation shielding material is configured to attenuate radiation.

### CROSS-REFERENCE TO RELATED APPLICATIONS

This application claims priority to U.S. Application No. 63/734,336, titled Radiation Shielding Garment, Method of Using and Making the Same, filed Dec. 16, 2024, which is hereby incorporated by reference in its entirety.

### FIELD OF INVENTION

The present disclosure relates to radiation shielding garments for use in medical procedures, and more particularly to a lightweight radiation shielding garment having a modular back panel and expandable portions configured to reduce weight and accommodate users of varying sizes, along with universal garments configured to fit users of different heights, and other garments and features.

### BACKGROUND

Medical professionals working in environments involving radiation exposure, such as catheterization laboratories, radiology rooms, and health imaging departments, routinely wear protective garments to shield themselves from harmful radiation. These radiation shielding garments typically incorporate materials such as lead, lead composites, or lead-free alternatives that attenuate both primary radiation from sources such as X-ray tubes and scattered radiation resulting from interactions between radiation beams and body tissue or other substances.

Conventional radiation shielding garments present several challenges for medical professionals who wear them during extended procedures. The weight of radiation shielding materials can cause fatigue, discomfort, and musculoskeletal strain when garments are worn for prolonged periods. This weight burden may affect the performance and well-being of healthcare workers who perform multiple procedures throughout a workday.

Additionally, radiation shielding garments are often available in multiple sizes to accommodate different body types, which can create inventory and logistics challenges for healthcare facilities. The fit of these garments may also affect the level of protection provided, as gaps or improper coverage can result in radiation exposure to unprotected areas.

Heat retention is another consideration with radiation shielding garments. The materials used for radiation attenuation, combined with the coverage area of the garment, can limit airflow and ventilation, potentially causing discomfort during extended wear.

Various approaches have been developed to address these considerations, including weight support systems that transfer garment weight from the shoulders to the hips, suspension systems that support garments from external structures, and garment designs that incorporate different levels of shielding in different areas. However, opportunities remain for improvements in radiation shielding garment design that address weight, fit, ventilation, and modularity considerations.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

An advantage of the invention is the provision of a lightweight radiation-shielding garment that allows continued use to reduce fatigue.

Another advantage of the invention is the provision of a one-size-fits-all radiation shielding garment that allows use by individuals ranging in height from approximately 5′2″ to approximately 6′5″ or greater.

According to an aspect of the present disclosure, a radiation shielding apparatus is provided. The radiation shielding apparatus includes a front portion configured to cover a torso of a user. The front portion includes a left front portion and a right front portion. The radiation shielding apparatus includes a back portion connected to the front portion. The back portion includes a plurality of openings arranged in a pattern. The back portion includes at least one expandable portion having a plurality of holes. The back portion includes an expandable mechanism extending through the plurality of holes. The expandable mechanism is configured to expand with pressure applied by the user. The radiation shielding apparatus includes a radiation shielding material arranged within the front portion. The radiation shielding material is configured to attenuate radiation.

According to other aspects of the present disclosure, the radiation shielding apparatus may include one or more of the following features. The plurality of openings may be hexagonal openings. The expandable mechanism may be an elastic cord woven through the plurality of holes. The at least one expandable portion may include a first expandable portion and a second expandable portion positioned on opposite sides of the plurality of openings. The radiation shielding apparatus may further include a detachable back panel configured to removably attach to the back portion. The detachable back panel may include radiation shielding material. The radiation shielding apparatus may further include at least one attachment mechanism configured to secure the detachable back panel to the back portion. The at least one attachment mechanism may include a hook-and-loop fastener. The radiation shielding apparatus may include an upper attachment mechanism, a first lower attachment mechanism, and a second lower attachment mechanism. The radiation shielding material may include a laminated structure having an outer layer, an inner layer, and a core material arranged between the outer layer and the inner layer. The core material may include one or more of a light lead radiation shielding material, a lead radiation shielding material, and a lead free radiation shielding material configured to have a lead equivalence in a range from about 0.125 mm to about 1.0 mm. The front portion may include a front entry configuration with a closure mechanism. The closure mechanism may include one or more of a hook-and-loop fastener, a snap, a zipper, and a magnetic buckle. The front portion may include a side entry configuration with a side opening.

According to another aspect of the present disclosure, a radiation shielding apparatus is provided. The radiation shielding apparatus includes a front portion configured to cover a torso of a user. The radiation shielding apparatus includes a back portion connected to the front portion. The back portion includes a plurality of hexagonal openings. The back portion includes a first expandable portion positioned on a first side of the plurality of hexagonal openings. The first expandable portion includes first holes. The back portion includes a second expandable portion positioned on a second side of the plurality of hexagonal openings opposite the first side. The second expandable portion includes second holes. The back portion includes an elastic cord extending through the first holes and the second holes. The elastic cord is configured to expand when the user breathes. The radiation shielding apparatus includes a radiation shielding material arranged within the front portion. The radiation shielding apparatus includes a detachable back panel configured to removably cover the back portion. The detachable back panel includes radiation shielding material.

According to other aspects of the present disclosure, the radiation shielding apparatus may include one or more of the following features. The radiation shielding apparatus may further include an upper attachment mechanism positioned at an upper region of the back portion. The radiation shielding apparatus may further include a first lower attachment mechanism positioned at a first lower region of the back portion and a second lower attachment mechanism positioned at a second lower region of the back portion. The upper attachment mechanism, the first lower attachment mechanism, and the second lower attachment mechanism may each include a hook-and-loop fastener. The front portion may include a side opening configured to allow the user to don and doff the radiation shielding apparatus from a side of the user. The detachable back panel may extend past a bottom of the back portion to cover a portion of legs of the user.

According to another aspect of the present disclosure, a radiation shielding apparatus configured to fit users of different sizes is provided. The radiation shielding apparatus includes a front portion configured to cover a torso of a user. The front portion includes a left front portion and a right front portion. The radiation shielding apparatus includes a left shoulder portion connected to the left front portion. The radiation shielding apparatus includes a right shoulder portion connected to the right front portion. The radiation shielding apparatus includes a closing mechanism configured to secure the front portion around the user. The radiation shielding apparatus includes an outside rear panel connected to the front portion. The outside rear panel includes an adjustable opening configured to accommodate users ranging in height from about 5 feet 2 inches to about 6 feet 5 inches. The radiation shielding apparatus includes an inside rear panel configured to attach to the outside rear panel. The inside rear panel includes side radiation shielding regions configured to protect side body areas of the user. The radiation shielding apparatus includes a radiation shielding material arranged within the front portion, the outside rear panel, and the inside rear panel.

According to other aspects of the present disclosure, the radiation shielding apparatus may include one or more of the following features. The closing mechanism may include a zipper. The radiation shielding apparatus may further include a plurality of attachment mechanisms configured to secure the inside rear panel to the outside rear panel. The plurality of attachment mechanisms may include hook-and-loop fasteners. The adjustable opening may be positioned at a lower portion of the outside rear panel and the inside rear panel.

According to another aspect of the present disclosure, a radiation shielding skirt apparatus is provided. The radiation shielding skirt apparatus includes a front portion configured to cover lower extremities of a user. The front portion includes a front panel. The radiation shielding skirt apparatus includes a rear portion connected to the front portion. The rear portion includes a rear panel. The radiation shielding skirt apparatus includes a closure mechanism configured to secure the radiation shielding skirt apparatus around a waist or hips of the user. The radiation shielding skirt apparatus includes at least one pocket positioned on the front portion or the rear portion. The radiation shielding skirt apparatus includes a radiation shielding material arranged within the front panel and the rear panel. The radiation shielding skirt apparatus includes at least one attachment mechanism positioned on the rear panel.

According to other aspects of the present disclosure, the radiation shielding skirt apparatus may include one or more of the following features. The rear panel may include an upper edge and a grip material. The at least one attachment mechanism may include a hook-and-loop fastener.

According to another aspect of the present disclosure, a method of assembling a radiation shielding apparatus is provided. The method includes forming a laminated structure having an outer layer, an inner layer, and a radiation shielding core material arranged between the outer layer and the inner layer. The method includes basting the radiation shielding core material between the outer layer and the inner layer. The basting includes attaching the layers together by one or more of stitching, fastening, zipping, adhering, fusing, tacking, seaming, and hemming. The method includes binding the laminated structure to form a wearable garment configured to cover a torso of a user. The method includes forming a back portion having a plurality of openings arranged in a pattern. The method includes forming at least one expandable portion in the back portion. The at least one expandable portion includes a plurality of holes. The method includes extending an expandable mechanism through the plurality of holes. The expandable mechanism is configured to expand with pressure applied by the user.

According to other aspects of the present disclosure, the method may include one or more of the following features. The method may further include attaching a detachable back panel to the back portion using at least one attachment mechanism. The at least one attachment mechanism may include a hook-and-loop fastener. The plurality of openings may be hexagonal openings. The expandable mechanism may be an elastic cord.

The foregoing general description of the illustrative embodiments and the following detailed description thereof are merely exemplary aspects of the teachings of this disclosure and are not restrictive.

The foregoing general description of the illustrative embodiments and the following detailed description thereof are merely exemplary aspects of the teachings of this disclosure and are not restrictive.

### BRIEF DESCRIPTION OF FIGURES

The accompanying drawings, which are included to provide a further understanding of the invention and are incorporated in and constitute a part of this specification, illustrate embodiments of the invention and together with the description serve to explain the principles of the invention.

In the Drawings:

FIG. 1 illustrates an front view of a radiation shielding apparatus with an open back design, according to aspects of the present disclosure.

FIG. 2 illustrates a side view of the radiation shielding apparatus of FIG. 1, according to an embodiment.

FIG. 3 illustrates a different side view of the radiation shielding apparatus of FIG. 1, according to an embodiment.

FIG. 4 illustrates a rear view of the radiation shielding apparatus of FIG. 1 with expandable portions, according to aspects of the present disclosure.

FIG. 5 illustrates a partially assembled flat view of the radiation shielding apparatus of FIG. 1 with a magnified section showing a single piece layered construction, according to an embodiment.

FIG. 6 illustrates a rear view of a radiation shielding apparatus with a detachable back portion, according to aspects of the present disclosure.

FIG. 7 illustrates a rear view of the radiation shielding apparatus of FIG. 6 with the detachable back portion removed, according to an embodiment.

FIG. 8 illustrates a rear view of the radiation shielding apparatus of FIG. 6 with a partially attached back portion in a first configuration according to aspects of the present disclosure.

FIG. 9 illustrates a front view of a radiation shielding apparatus configured as a side entry apparatus, according to aspects of the present disclosure.

FIG. 10 illustrates a side view of the radiation shielding apparatus of FIG. 9, according to an embodiment.

FIG. 11 illustrates a different side view of the radiation shielding apparatus of FIG. 9, according to an embodiment.

FIG. 12 illustrates a partially assembled flat view of a first side of the radiation shielding apparatus of FIG. 9 with expandable portions, according to aspects of the present disclosure.

FIG. 13 illustrates a partially assembled flat view of an opposite side of the radiation shielding apparatus of FIG. 9 with expandable portions, according to aspects of the present disclosure.

FIG. 14 illustrates a rear view of a radiation shielding apparatus with a detachable back portion, according to aspects of the present disclosure.

FIG. 15 illustrates a rear view of the radiation shielding apparatus of FIG. 14 with the detachable back portion removed, according to an embodiment.

FIG. 16 illustrates a rear view of the radiation shielding apparatus of FIG. 14 with a partially attached back portion in a first configuration according to aspects of the present disclosure.

FIG. 17 illustrates a side view of a radiation shielding apparatus configured to accommodate different sized users, according to aspects of the present disclosure.

FIG. 18 illustrates a side view of the radiation shielding apparatus of FIG. 17, according to an embodiment.

FIG. 19 illustrates a different side view of the radiation shielding apparatus of FIG. 17, according to an embodiment.

FIG. 20 illustrates a rear view of the radiation shielding apparatus of FIG. 17 with an adjustable opening, according to aspects of the present disclosure.

FIG. 21 illustrates an unassembled outside view of a rear panel for the radiation shielding apparatus of FIG. 17, according to an embodiment.

FIG. 22 illustrates an unassembled inside view of a rear panel for the radiation shielding apparatus of FIG. 17, according to an embodiment.

FIG. 23 illustrates unassembled front panels for the radiation shielding apparatus of the radiation shielding apparatus of FIG. 17 in a flat configuration, according to aspects of the present disclosure.

FIG. 24 illustrates front views of the radiation shielding apparatus of FIG. 17 arranged on persons of different heights, according to an embodiment.

FIG. 25 illustrates a front view of a radiation shielding apparatus, according to aspects of the present disclosure.

FIG. 26 illustrates a side view of the radiation shielding apparatus of FIG. 25, according to an embodiment.

FIG. 27 illustrates a different side view of the radiation shielding apparatus of FIG. 25, according to an embodiment.

FIG. 28 illustrates a partially assembled flat view of a first of the radiation shielding apparatus of FIG. 25 with a magnified region showing layered construction, according to aspects of the present disclosure.

FIG. 29 illustrates an perspective view of a radiation shielding apparatus configured as a skirt, according to aspects of the present disclosure.

FIG. 30 illustrates a partially assembled flat view of a first side of the radiation shielding apparatus of FIG. 30 with expandable portions, according to aspects of the present disclosure.

FIG. 31 illustrates a partially assembled flat view of a first side of the radiation shielding apparatus of FIG. 30 with expandable portions, according to aspects of the present disclosure.

### DETAILED DESCRIPTION

The following detailed description of the invention is directed to a radiation shielding garment, and method of making and using the same that substantially obviates one or more of the problems due to limitations and disadvantages of the related art, and is presented to enable any person skilled in the art to make and use the disclosed subject matter in the context of one or more particular implementations. In one embodiment, the radiation shielding garment is configured with use for a shoulder transfer weight support system.

Various modifications, alterations, and permutations of the disclosed implementations can be made and will be readily apparent to those skilled in the art, and the general principles defined may be applied to other implementations and applications, without departing from scope of the disclosure. The present disclosure is not intended to be limited to the described or illustrated implementations, but to be accorded the widest scope consistent with the described principles and features.

Appearances of the phrases “an aspect”, “an embodiment,” “implementation,” “an example,” or similar language in this specification may, but do not necessarily, refer to the same embodiment, to different embodiments, or to one or more of the figures. The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps unless explicitly stated otherwise.

In one embodiment, a radiation shielding apparatus or radiation shielding garment is optionally configured to be integrated or not integrated with a shoulder transfer weight support system as described herein. The shoulder transfer weight support system can be any weight support system, e.g., the shoulder transfer weight support described with reference to: U.S. Pat. Nos. 10,729,195, 11,627,795, U.S. patent application Ser. No. Ser. No. 18/134,394, U.S. patent application Ser. No. 18/134,394, and U.S. patent application Ser. No. 18/234,796, each of the patents are hereby fully incorporated by reference for these teachings and fully part of this document as if fully set forth herein.

As used herein the term radiation shielding apparatus and radiation shielding garment are used interchangeably herein. The term radiation is radiation that is blocked and/or attenuated by the radiation apparatus and can include either or both primary or scattered radiation. Primary radiation is radiation coming directly from a source, such as a C-arm emission of an X-ray tube, without interactions with matter and scattered radiation and leakage from the X-ray tube. Scattered radiation includes radiation that spreads out in different directions from a radiation beam when the beam interacts with a substance, such as body tissue.

According to another aspect of the present disclosure, a radiation shielding garment includes a single-piece laminated structure including one or more outer layers, one or more inner layers, and one or more radiation shielding layers, e.g., core material, disposed between the outer and inner layers. The layers are secured together only along a peripheral edge region of the laminated structure, such as by basting, clipping, hemming, binding, adhering, fusing, or other attachment techniques, such that no seams, stitch lines, holes, or penetrations extend through the radiation shielding core material within the primary radiation-blocking area. By limiting attachment to the perimeter, the laminated structure defines a continuous, uninterrupted radiation shielding region that minimizes or eliminates radiation leakage paths associated with internal seams or stitching. The laminated structure is then bound to form a wearable, one-piece garment configured to cover at least a portion of a user's torso.

In one embodiment, the inner layer and outer layer materials can include one or more layers of textile or fabric material selected for durability, flexibility, comfort, and protection. Suitable materials include, by way of example and not limitation, nylon (including branded variants such as Cordura®), polyester, aramid fibers such as Kevlar®, or combinations thereof, and may be woven or non-woven. Woven constructions may include, for example, canvas, twill, ripstop, or similar weaves.

In one embodiment, the outer layer is selected to provide enhanced abrasion resistance, puncture resistance, and tear strength, such as through the use of high-denier nylon, aramid fibers, reinforced weaves, or coated fabrics, thereby protecting the radiation shielding core material from damage during use. In contrast, the inner layer may be selected to prioritize wearer comfort, flexibility, and breathability, and may include softer textiles, moisture-managing fabrics, or lighter-weight constructions.

In one embodiment, one or both of the inner and outer layers may be laminated or coated, or uncoated, with coatings or membranes including polytetrafluoroethylene (PTFE) membranes (e.g., Gore-Tex®), polyurethane membranes (e.g., eVent® or similar), polyurethane coatings, polyvinyl chloride (PVC) coatings, or combinations thereof. Additionally, one or more of the inner or outer layers may be treated with a durable water repellent (DWR) or similar surface treatment to enhance water repellency, resistance to contamination, and overall service life of the apparatus.

In one embodiment, a back portion or panel is configured to reduce weight and allow for enhanced breathability and movement of the user. The back portion can includes a reduced length portion as compared to the front panel and a plurality of openings arranged in a pattern, and at least one expandable portion positioned in the back portion, the at least one expandable portion having a plurality of holes and an expandable mechanism extending through the plurality of holes, the expandable mechanism configured to expand with pressure applied by the user. The back portion does not include a radiation shielding material, e.g., a core material, and is configured to be expandable, breathability, and allow for reduced overall weight of the apparatus. In one embodiment, the back panel may be attached to the garment via hemming, stitching, adhesive bonding, thermal welding, ultrasonic welding, laser welding, fusing, binding, mechanical fastening, or other attachment techniques as described herein, or combinations thereof.

In one embodiment, the plurality of openings in the back panel or portion may be hexagonal openings, circular openings, or openings of any geometric shape, including an assortment of different geometric shapes. The expandable mechanism may include an elastic cord woven through the plurality of holes and arranged to permit controlled expansion and contraction in response to movement of an individual, thereby accommodating changes in position or body motion while maintaining engagement with the device. The openings may be formed by laser cutting or by other machining or fabrication techniques, including die cutting, waterjet cutting, punching, CNC cutting, or combinations thereof.

In one embodiment, the back panel can includes a laminated fabric formed from two layers of Cordura® nylon canvas bonded to each other, commonly referred to as Squadron™ fabric. By way of example, the Squadron™ fabric may comprise a double-layer construction including a solution-dyed 500 denier (500 D) Cordura® nylon layer laminated to a solution-dyed 1000 denier (1000 D) Cordura® nylon layer, thereby providing enhanced durability, abrasion resistance, and water repellency. The laminated construction increases structural integrity and resistance to wear while maintaining flexibility suitable for wearable applications. In other embodiments, the back panel may comprise materials that are the same as or functionally equivalent to Squadron™ fabric, including other multi-layer or laminated high-denier nylon fabrics, polyester fabrics, aramid-based fabrics, or composite textiles providing comparable strength, abrasion resistance, puncture resistance, and water-repellent characteristics.

In one embodiment, the core material may include one or more layers, e.g. a light lead radiation shielding material, a lead radiation shielding material, and a lead free radiation shielding material configured to have a lead equivalence in a range from about 0.125 mm to about 1.0 mm. The core material may comprise a radiation protection vinyl constructed of a high atomic weight element on one layer and a lower atomic weight element on another layer. The core material may comprise an edge bilayer material having two distinct homogenous layers as one integral sheet with specially graded metal particles distributed evenly within a vinyl matrix of each layer. The core material may comprise a composition including emulsion polymers, plasticizers, finely divided lead and lead-free particles, stabilizers, and pigments.

In one embodiment, the core material may include one or more layers of materials, e.g., two layers, three layers, four layers, five layers, and so one.

According to another aspect of the present disclosure, a radiation shielding apparatus is provided includes a front portion configured to cover a torso of a user, the front portion includes a radiation shielding material configured to attenuate radiation, a light weight expandable back portion connected to the front portion. The back portion including a plurality of openings arranged in a pattern, at least one expandable portion having a plurality of holes, and an expandable mechanism extending through the plurality of holes. The expandable mechanism configured to expand with pressure applied by the user. The back panel or portion is breathable with the holes and does not include radiation shielding materials. The garment also includes a removable or detachable back panel configured to removably attach over the expandable back panel. The detachable back panel comprising a laminated structure having three layers including one or more outer layers, one or more inner layers, and one or more radiation shielding layers have a core material arranged between the outer layer and the inner layer, the core material comprising a radiation shielding material. In this embodiment, the user can add the back panel when desired to provide radiation protection or remove and reduce weight of the apparatus and enhance breathability. The radiation shielding apparatus may further include at least one attachment mechanism configured to secure the detachable back panel to the back portion, the at least one attachment mechanism includes a hook-and-loop fastener or other type of releasability attached fastener described herein. The at least one attachment mechanism may include an upper attachment mechanism positioned at an upper region of the back portion, a first lower attachment mechanism positioned at a first lower region of the back portion, and a second lower attachment mechanism positioned at a second lower region of the back portion. The detachable back panel may extend past a bottom of the back portion to cover a portion of legs of the user.

In one embodiment, core material of the detachable back panel or any panel herein may include one or more of a light lead radiation shielding material, a lead radiation shielding material, and a lead free radiation shielding material configured to have a lead equivalence in a range from about 0.125 mm to about 1.0 mm.

According to another aspect of the present disclosure, a radiation shielding garment is provided to fit a wide range of individuals having different heights and weights. For example, the radiation shielding garment can accommodate a height from approximately 5 feet to approximately 6 feet or greater by allowing adjustments of the panels. The panels have adjustment mechanisms such as one or more fastening elements selected from the group consisting of a zipper, a hook-and-loop fastener (e.g., Velcro®), snaps, magnetic fasteners, or any combination thereof. In addition, the front toros has two panels connect with a closing mechanism is configured to selectively secure opposing portions of the device together while allowing repeated opening and closing for donning, doffing, adjustment, or resizing. Other fastening mechanisms providing similar functionality may likewise be used without departing from the scope of the disclosure.

According to another aspect of the present disclosure, a radiation shielding skirt formed from a single piece of laminated material including one or more inner layers, one or more radiation shielding layers, and one more outer layers connect an peripheral seam. The outer layer forming an exterior surface of the skirt, an inner layer forming an interior surface of the skirt, a core material arranged between the outer layer and the inner layer, the core material comprising a radiation shielding material configured to attenuate radiation, a front portion configured to cover lower extremities of a user, a rear portion connected to the front portion, a closure mechanism configured to secure the radiation shielding skirt around a waist or hips of the user, and at least one pocket positioned on at least one of the front portion and the rear portion.

According to other aspects of the present disclosure, the radiation shielding skirt may include one or more of the following features. The rear panel may include a grip material configured to maintain a position of the radiation shielding skirt on the user during movement. The rear panel may further include at least one attachment mechanism positioned near an upper edge of the rear panel. The attachment mechanism may include one or more fastening elements selected from the group consisting of a zipper, a hook-and-loop fastener (e.g., Velcro®), buckle, snaps, magnetic fasteners, or any combination thereof. The closing mechanism is configured to selectively secure opposing portions of the device together while allowing repeated opening and closing for donning, doffing, adjustment, or resizing. Other fastening mechanisms providing similar functionality may likewise be used without departing from the scope of the disclosure. The core material may include one or more of a light lead radiation shielding material, a lead radiation shielding material, and a lead free radiation shielding material configured to have a lead equivalence in a range from about 0.125 mm to about 1.0 mm. The core material may comprise a radiation protection vinyl constructed of a high atomic weight element on one layer and a lower atomic weight element on another layer.

In one embodiment, the grip material the grip materials suitable for use with fabrics may include elastomeric, polymeric, foam, or textured materials configured to increase friction and reduce slippage during use. By way of example and not limitation, such grip materials may include silicone (e.g., printed, coated, or injected), thermoplastic rubber (TPR), thermoplastic elastomers (TPE), natural or synthetic rubbers (including nitrile or neoprene), polyurethane (PU) coatings, polyvinyl chloride (PVC) coatings, acrylic or latex-based coatings, and rubberized fabric laminates. Additional grip configurations may include raised or textured patterns such as micro-dot or macro-dot prints, embossed or debossed polymer textures, heat-transfer grip films, screen-printed or spray-applied friction coatings, and flocked or high-friction woven or knit inserts. In some embodiments, foam-based grip materials such as neoprene foam, EVA foam, or polyurethane foam may be used to provide both friction and cushioning. One or more of these grip materials may be applied as a coating, laminate, insert, or printed pattern on a fabric surface to enhance stability and retention of the garment during wear.

According to another aspect of the present disclosure, a method of using a radiation shielding garment configured to fit users of different sizes is provided comprising selecting the radiation shielding garment, e.g., a garment having a front portion, shoulder portions, an outside rear panel with an adjustable opening, and an inside rear panel with side radiation shielding regions, adjusting the adjustable opening to accommodate a height of a user ranging from approximately 5 feet 2 inches to approximately 6 feet 5 inches, donning the radiation shielding garment on the user, securing the radiation shielding garment around the user using a closing mechanism, and positioning the user in an environment having radiation exposure.

In one embodiment, the radiation shielding garment includes a vest garment, a full piece vest, a skirt garment, and other garments. The radiation shielding garment includes radiation shielding materials, e.g., lead material, non-lead material and/or low lead material. The radiation shielding materials are configured to protect against radiation, e.g., against the highest attenuation levels available, for health professionals in various environments, e.g., Cath labs, Radiology rooms, health imaging departments and the like.

In one embodiment, the radiation shielding material or core material can include materials that are flexible and lightweight such as flexible lead and lead-free vinyl radiation shielding materials from Kemmetech. In one embodiment, the lead equivalent values of one or more of 0.125 mm, 0.167 mm, 0.175 mm, 0.25 mm, 0.35 mm, 0.50 mm, 0.70 mm, and 1.00 mm depending on level of protection desired. The composition can include emulsion polymers, plasticizers, finely divided lead and lead-free particles, stabilizers and pigments.

In one embodiment, the core material includes one or more of a light lead radiation shielding material, a lead radiation shielding material, and a lead free radiation shielding material configured to a have a lead equivalence in range from about 0.125 mm to about 1.0 mm or greater.

In one embodiment, the radiation shielding material is configured to a have a lead equivalence in range from about 0.125 mm to about 1.0 mm.

In a preferred embodiment, the radiation shielding material includes a radiation protection vinyl, e.g., one or more sheets of material, constructed of a high atomic weight element on one layer and a lower atomic weight element on another layer. In another embodiment, the material is edge bilayer from Kemmetech having a construction of two distinct homogenous layers as one integral sheet. The material can be distributed evenly to as specially graded metal particles (e.g., lead/non-Lead) within the vinyl matrix of each layer and therefore a consistent level of protection. In one embodiment, one or more of the following can be used Kemmetech LE Edge Bilayer 0.175 Bilayer Low Lead, 0.25 LE Bi-Layer Low Lead, 0.35 LE Bi-Layer Low Lead, 0.5 LE Bi-Layer Low Lead, 0.175 0.25 LE Bi-Layer Lead Free, 0.250 LE Bi-Layer Lead Free, 0.35 LE Bi-Layer Lead Free, 0.50 LE Bi-Layer Lead Free, 0.125 LE Lightweight Lead, 0.167 LE Lightweight Lead, 0.175 LE Lightweight Lead, 0.250 LE Lightweight Lead, 0.350 LE Lightweight Lead, 0.125 LE Superlight Lead, 0.167 LE Superlight Lead, 0.175 LE Superlight Lead, 0.250 LE Superlight Lead, 0.350 LE Superlight Lead, 0.125 LE Lead Free, 0.167 LE Lead Free, 0.175 LE Lead Free, 0.250 LE Lead Free, 0.350 LE Lead Free combinations of the same and the like.

In another embodiment, other lead-free and lead composite products, e.g., containing low Z (atomic number) materials either exclusively or in a mixed metal composite can be utilized.

In one embodiment, a shoulder transfer weight support system is configured to be used with a radiation shielding garment. The weight supporting device includes an exoskeleton configured to bear the weight of a radiation shielding garment. In various embodiments, the radiation shielding garment is configured to be arranged and at least partially supported by the weight supporting device. In another embodiment, the radiation shielding apparatus includes a vest garment, a skirt garment, and a scarf garment, wherein the vest garment, the skirt garment, and the scarf garment are configured to be at least partially supported by the weight supporting device and also configured to protect the user from radiation exposure.

In one embodiment, a method of assembling a radiation shielding vest includes forming a single-piece laminated structure comprising an outer layer, an inner layer, and a radiation shielding core material disposed between the outer and inner layers. The layers are secured together only along a peripheral edge region of the laminated structure, such as by basting, clipping, hemming, binding, adhering, fusing, or other attachment techniques, such that no seams, stitch lines, holes, or penetrations extend through the radiation shielding core material within the primary radiation-blocking area. By limiting attachment to the perimeter, the laminated structure defines a continuous, uninterrupted radiation shielding region that minimizes or eliminates radiation leakage paths and scatter radiation leakage paths that could otherwise result from internal seams, stitching, or apertures. The laminated structure is then bound to form a wearable, one-piece garment configured to cover at least a portion of a user's torso.

In one embodiment, the weight supporting device includes an exoskeleton configured to bear at least some of the weight of a radiation shielding garment. In various embodiments, the radiation shielding garment is configured to be arranged and at least partially supported by the weight supporting device. In another embodiment, the radiation shielding garment includes a vest that is configured to protect a user's upper body, e.g., torso, a skirt configured to protect a user's lower extremities, e.g., legs, and a scarf configured to protect a user's neck and thyroid region. The shielding garment is configured to be at least partially supported by the weight supporting device and configured to protect the user from radiation exposure. Optionally and/or alternatively, the radiation shielding apparatus can also include sleeves, pants, and or shirts constructed with laminated materials described herein.

In one embodiment, the vest, skirt, and scarf may each be configured to couple to the weight supporting device, e.g., exoskeleton. The weight supporting device may include a waist portion including opposing ends coupled by a hook-and-loop fastener. The waist portion may be configured to encircle a user's waist and/or hips. To further secure the weight supporting device to a user's waist, the waist portion may also include a buckle in addition to the hook-and-loop fastener or other securing mechanism. The weight supporting device may further include one strap or more straps configured to stabilize the shoulder portion during use. The strap is also configured to adjust to users of varying sizes.

In one embodiment, any of the radiation shielding garments may include interior portions, e.g., belt loops, that may complement the shoulder and waist portions of the weight supporting device. Accordingly, a user may slide the portions of the weight supporting device, e.g., mantis bars or shoulder bars, through the interior loops, thereby integrating the weight supporting device with the vest. The weight supporting device and vest may further include a plurality of complementary attachment mechanisms, e.g., snaps, buttons, magnets, that are configured to further secure the weight supporting device to the vest.

In one embodiment, the scarf includes opposing ends configured to be at least partially coupled by a hook-and-loop fastener. In another embodiment, the scarf may include a buckle configured to couple the opposing ends of the scarf.

Reference will now be made in detail to an embodiment of the present invention, example of which is illustrated in the accompanying drawings.

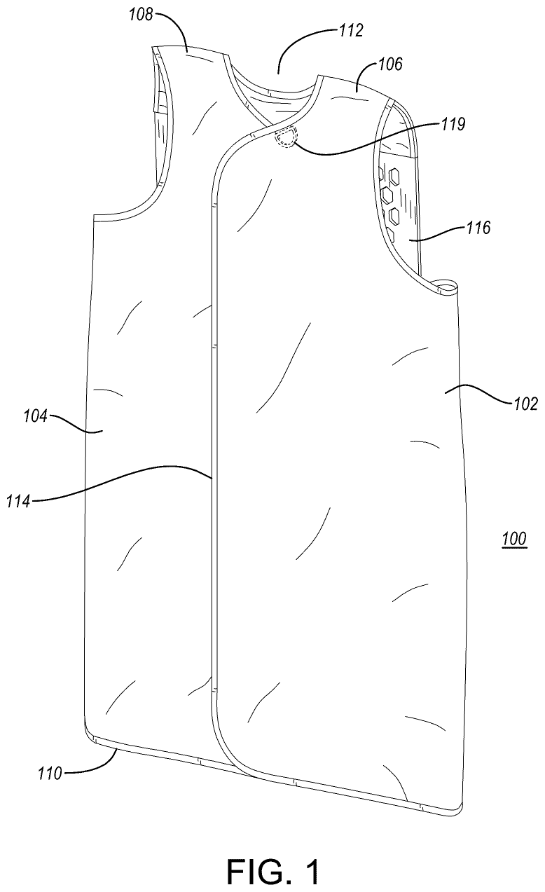

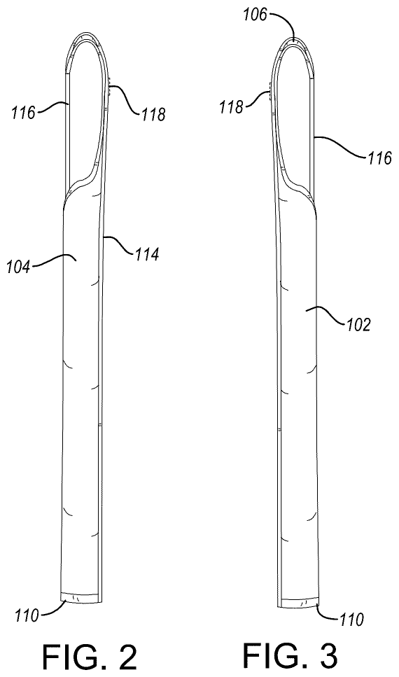

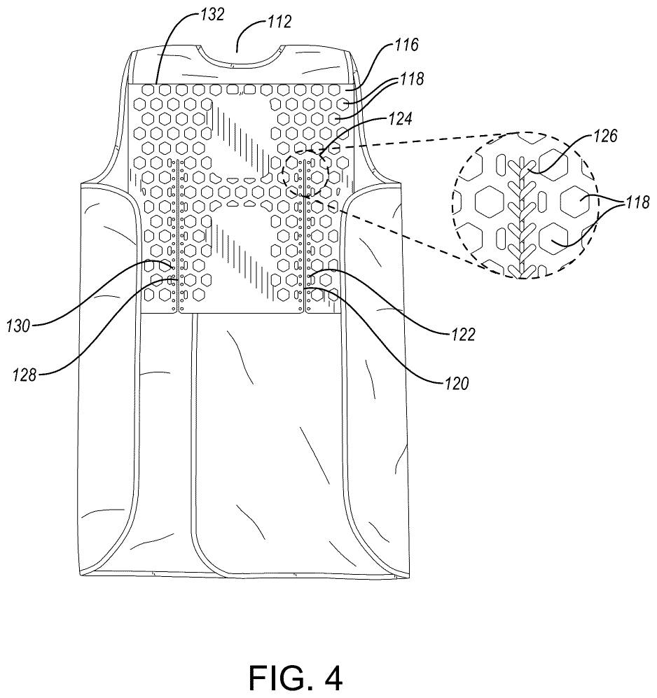

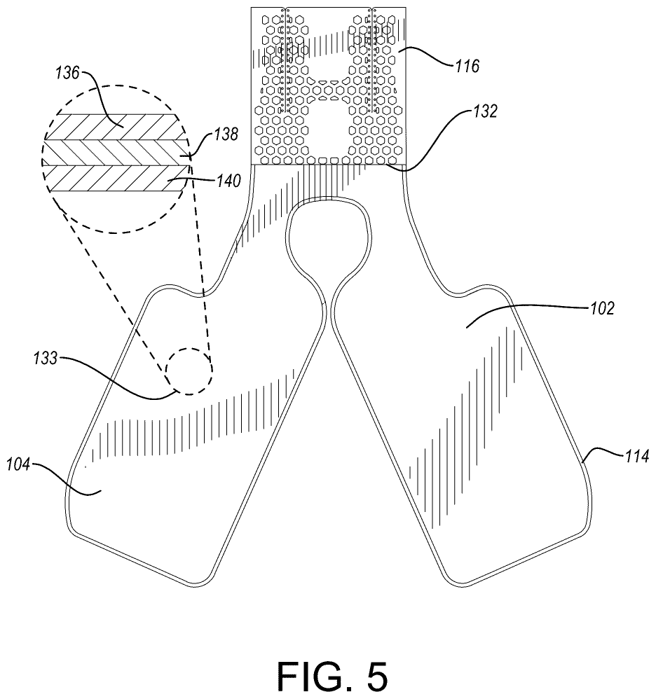

FIG. 1 illustrates an front view of a radiation shielding apparatus with an open back design, according to aspects of the present disclosure. FIG. 2 illustrates a side view of the radiation shielding apparatus of FIG. 1, according to an embodiment. FIG. 3 illustrates a different side view of the radiation shielding apparatus of FIG. 1, according to an embodiment. FIG. 4 illustrates a rear view of the radiation shielding apparatus of FIG. 1 with expandable portions, according to aspects of the present disclosure. FIG. 5 illustrates a partially assembled flat view of the radiation shielding apparatus of FIG. 1 with a magnified section showing a single piece layered construction, according to an embodiment.

Referring to FIGS. 1-5, a radiation shielding apparatus 100 with an open back to reduce weight is shown. The radiation shielding apparatus 100 includes a left front portion 102 and a right front portion 104, which together form the front coverage area of the garment. The radiation shielding apparatus 100 further includes a left shoulder portion 106 and a right shoulder portion 108, which extend over the shoulders of a wearer. A neck opening 112 is positioned at an upper region of the radiation shielding apparatus 100 to accommodate the wearer's neck. The radiation shielding apparatus 100 includes a back portion 116 that features an openings in the design to reduce the overall weight of the garment. In addition, the back portion does not include a core material. A seam 114 is visible along the edges of radiation shielding apparatus 100, indicating where the single piece laminated structure is joined along a peripheral edge region, such that the seam 114 does not extend through the radiation shielding core material and does not create a radiation or scatter radiation leakage path through the apparatus. A D-ring 119 is positioned on the left shoulder portion 106, which may be used for attachment purposes or for securing additional components. The radiation shielding apparatus 100 includes a bottom 110 that defines the lower edge of the garment. The radiation shielding apparatus 100 may be configured as a front entry with a hook and loop closure mechanism for securing the garment, although other closure mechanisms may be utilized such as snaps, zippers, magnets, or combinations thereof. That is, the overlap of the portion 102 and 114 are configured to open to allow a user to enter the garment.

With continued reference to FIG. 1, the radiation shielding apparatus 100 is configured as a vest-style garment designed to provide radiation protection to the torso of a wearer while maintaining a lightweight construction through the open back design. The radiation shielding apparatus 100 may include any radiation core materials as described herein. In one embodiment, the radiation core materials, e.g., shielding materials, may include such as lead material, non-lead material, and/or low lead material. In some cases, the radiation shielding material may have lead equivalent values of 0.125 mm, 0.167 mm, 0.175 mm, 0.25 mm, 0.35 mm, 0.50 mm, 0.70 mm, or 1.00 mm depending on the level of protection desired. The radiation shielding material composition may include emulsion polymers, plasticizers, finely divided lead and lead-free particles, stabilizers, and pigments. In some cases, the radiation shielding material may include flexible lead and lead-free vinyl radiation shielding materials.

Referring to FIGS. 2 and 3, a profile of the garment as the radiation shielding apparatus 100 is shown. The side view reveals the contour and shape of the radiation shielding apparatus 100 along a lateral dimension, showing how the garment extends from the shoulder region down toward the bottom 110. FIG. 3 shows another side view of the radiation shielding apparatus 100, providing an alternative perspective of the garment profile. The side views demonstrate the overall silhouette and form of the radiation shielding apparatus 100, illustrating the garment configuration designed to provide radiation protection while maintaining a lightweight construction through the open back design.

Referring now to FIG. 4, a rear view of the radiation shielding apparatus 100 with the open back 116 configuration is shown. The back portion 116 features a distinctive open pattern construction. The back portion 116 incorporates a seam region 132 along an upper area near the neck opening 112. The seam 132 is configured to connect the laminate to the top portion of the radiation shielding apparatus 100 and the back 116. The seam 132 may be formed using one or more attachment techniques including stitching, laser welding, ultrasonic welding, thermal welding, adhesive bonding, fusing, hemming, binding, mechanical fastening, or combinations thereof.

The back portion 116 includes a first expandable portion 120 positioned on one side and a second expandable portion 128 positioned on an opposite side. The first expandable portion 120 contains first holes 122, while the second expandable portion 128 contains second holes 130. The first expandable portion 120 and the second expandable portion 128 are configured to accommodate movement and breathing of a user during wear as described herein.

With continued reference to FIG. 4, the back portion 116 further includes openings 118 arranged in a hexagonal pattern across a central region. The openings 118 may have any geometry as described herein. A magnified section 124 provides an enlarged view of structural details of the back portion 116, showing the openings 118 and an expandable mechanism 126. The expandable mechanism 126 can include an elastic cord, a resilient filament, an elastomeric band, a stretchable strap, a spring element, a woven elastic member, or other flexible biasing element woven, threaded, or routed through the openings 122 and configured to expand under applied pressure and contract upon release, thereby allowing the apparatus to conform to a user's body and permit comfortable breathing and other movement during use. The combination of the openings 118, the first expandable portion 120, the second expandable portion 128, and the elastic cord 134 provides flexibility and breathability to the garment while reducing overall weight compared to fully enclosed radiation shielding garments. The open pattern with expandable elastic regions in the back portion 116 allows the user to breath during extended wear and allows for other movement.

Referring now to FIG. 5, a top view of the radiation shielding apparatus 100 with the open back configuration is shown. The left front portion 102 and the right front portion 104 extend around the sides of the garment. The back portion 116 is positioned at an upper region of the radiation shielding apparatus 100 and features the pattern of openings 118 arranged in the hexagonal configuration. Of course, any geometry of opening can be utilized as described herein. The back portion 116 connects to the left front portion 102 and the right front portion 104 at the seam region 132. A magnified section 133 is shown to the left of the radiation shielding apparatus 100, providing detail of a layered construction of the garment. The magnified section 133 reveals an outer layer 136, a core material 138, and an inner layer 140 arranged in a laminated structure. The core material is described herein. The outer layer 136 forms an exterior surface of the garment, while the inner layer 140 forms an interior surface that contacts the wearer. The core material 138 is positioned between the outer layer 136 and the inner layer 140 and comprises radiation shielding material configured to protect the user from radiation exposure.

A seam 114 is visible along the front of the radiation shielding apparatus 100, indicating where the laminated structure (inner layer 136, core layer 138, and inner layer 140) is joined along a peripheral edge region, such that the seam 114 does not extend through the radiation shielding core material and does not create a radiation or scatter radiation leakage path through the apparatus. Again, the seam 114 is configured to connect the laminate to the top portion of the radiation shielding apparatus, and the seam 114 may be formed using one or more attachment techniques including stitching, laser welding, ultrasonic welding, thermal welding, adhesive bonding, fusing, hemming, binding, mechanical fastening, or combinations thereof.

In this embodiment, the back 116 is not a laminated and comprises materials herein. In a preferred embodiment, the back 116 includes a laminated fabric formed from two layers of Cordura® nylon canvas bonded to each other, commonly referred to as Squadron™ fabric. The back panel may be attached to the garment via hemming, stitching, adhesive bonding, thermal welding, ultrasonic welding, laser welding, fusing, binding, mechanical fastening, or other attachment techniques as described herein, or combinations thereof. The inner and outer layers may include any material described herein.

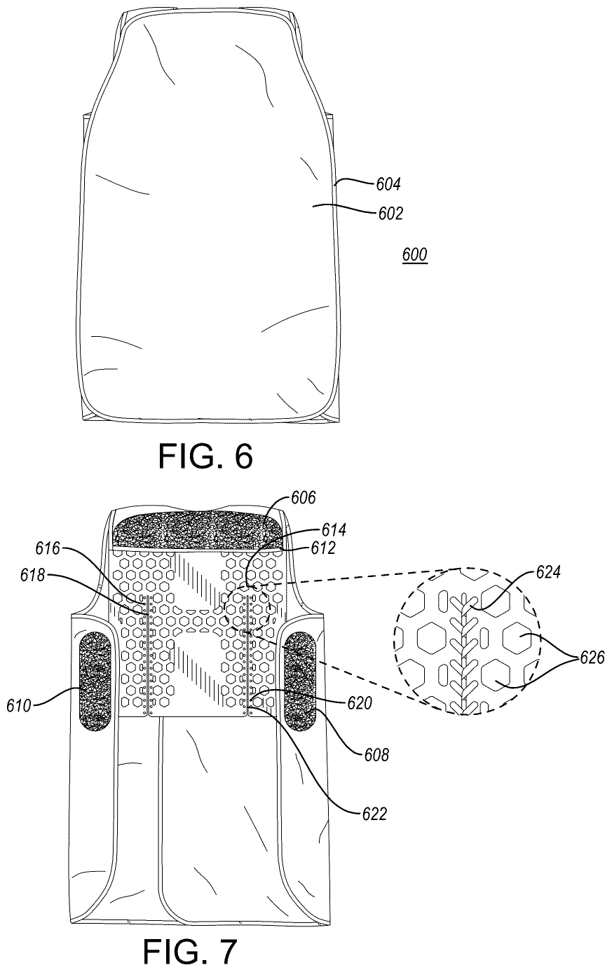

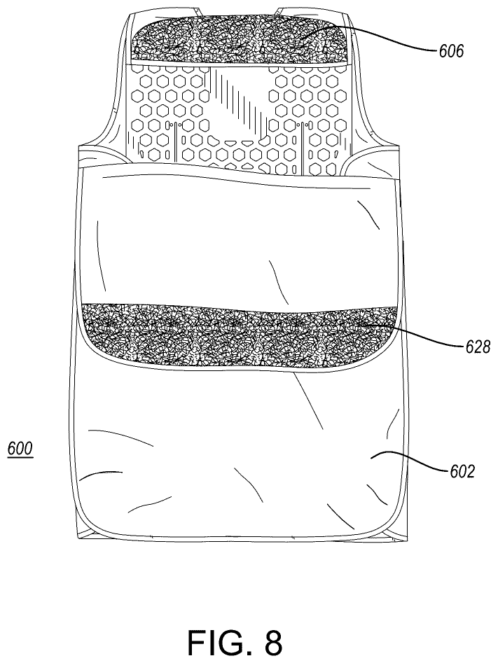

FIG. 6 illustrates a rear view of a radiation shielding apparatus with a detachable back portion, according to aspects of the present disclosure. FIG. 7 illustrates a rear view of the radiation shielding apparatus of FIG. 6 with the detachable back portion removed, according to an embodiment. FIG. 8 illustrates a rear view of the radiation shielding apparatus of FIG. 6 with a partially attached back portion in a first configuration according to aspects of the present disclosure.

Referring to FIGS. 6-8, a radiation shielding apparatus 600 with a cover to cover the open back is shown. The radiation shielding apparatus 600 includes a detachable back portion 602 that is configured to provide radiation protection to the back of a user when attached to a main garment body. In one embodiment, the radiation shielding apparatus 600 is formed from a single-piece laminated material comprising an outer layer, an inner layer, and a radiation shielding core material encapsulated therebetween. The laminated material is joined only along a peripheral seam 604 extending around an outer edge of the laminate, such that the peripheral seam 604 secures and contains the radiation shielding core material to prevent shifting or redistribution of the core material during use. By confining seams, stitching, or other attachment techniques to the peripheral edge region, the laminated structure maintains a continuous, uninterrupted radiation shielding area and minimizes or eliminates radiation and scatter-radiation leakage paths that could otherwise result from internal seams, perforations, or core displacement.

A peripheral seam 604 is visible along an upper region of the detachable back portion 602. FIG. 6 illustrates a front orthogonal view of the radiation shielding apparatus 600 with the detachable back portion 602 in a closed or attached position. FIG. 7 illustrates a rear view of the radiation shielding apparatus 600 with the detachable back portion 602 in a raised or partially open position, revealing an underlying back structure.

With continued reference to FIGS. 6 and 7, an upper attachment mechanism 606, such as a hook-and-loop fastener like Velcro™, is positioned at a top of the back portion and facilitates secure attachment of the detachable back portion 602 to the main body of the radiation shielding apparatus 600. A seam 612 extends across an upper region of the radiation shielding apparatus 600. A lower attachment mechanism 608 is positioned on one side of the back portion, while another lower attachment mechanism 610 is positioned on an opposite side. The lower attachment mechanism 608 and the lower attachment mechanism 610 are configured to secure the detachable back portion 602 to the main body of the radiation shielding apparatus 600. The back portion of the radiation shielding apparatus 600 may include three attachment points or regions for the detachable back portion 602, though more or fewer attachment points are possible. The lower attachment mechanisms 608 and 610 include one or more of hook-and-loop fastener like Velcro™, snaps, zippers, magnets, hook and loop, or combinations thereof.

As further shown in FIGS. 6 and 7, the back structure of the radiation shielding apparatus 600 includes a first expandable portion 620 and a second expandable portion 618 positioned on opposite sides of a central region. The first expandable portion 620 includes a plurality of holes 622, and the second expandable portion 618 includes plurality of holes 616. The first expandable portion 620 and the second expandable portion 618 are configured to accommodate users of varying sizes and allow for breathing comfort during use. The central region of the back structure features openings 626 arranged in a hexagonal pattern or other geometries described herein. A magnified section 614 provides a detailed view of the openings 626 and an expandable mechanism 624, such as an elastic cord, that is woven through the openings 626. The expandable mechanism 624 is configured to expand with pressure, thereby allowing the user to breathe comfortably and move while wearing the radiation shielding apparatus 600.

Referring to FIG. 8, a front view of the radiation shielding apparatus 600 configured with the cover to cover the open back is shown. The detachable back portion 602 provides radiation protection for the wearer's back region when desired. The detachable back portion 602 is secured to the main body of the radiation shielding apparatus 600 through the upper attachment mechanism 606, which may comprise a hook-and-loop fastener such as Velcro™. The upper attachment mechanism 606 is positioned near a top of the detachable back portion 602 and is shown with a textured pattern indicating the fastening material and configured to engage releasably with attachment mechanism 628. The radiation shielding apparatus 600 further includes an attachment mechanism 628 positioned in a middle region of the garment, which may also comprise a hook-and-loop fastener such as Velcro™. The attachment mechanism 628 provides additional securement for the detachable back portion 602 to the main body of the radiation shielding apparatus 600.

With continued reference to FIG. 8, the detachable back portion 602 features a hexagonal pattern in an upper section, indicating openings that may provide ventilation or reduce weight while maintaining radiation protection. A lower section of the detachable back portion 602 appears as a solid panel extending downward. The detachable back portion 602 is configured to be removably attached, enabling the wearer to customize the level of back protection based on radiation exposure requirements of a particular medical procedure. The detachable back portion 602 is configured to be used when a medical professional's back has exposure to radiation. The detachable back portion 602 covers a portion of a side body of the user. The detachable back portion 602 extends past legs of the user to provide extended coverage.

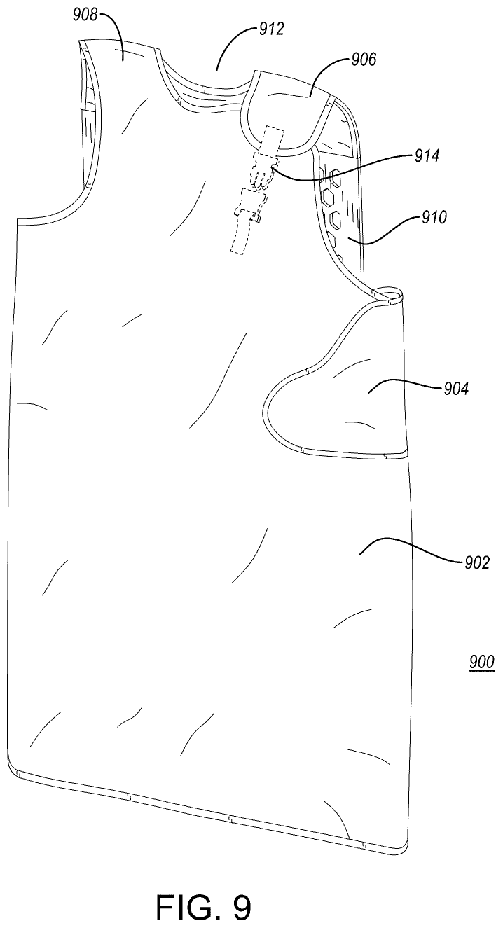

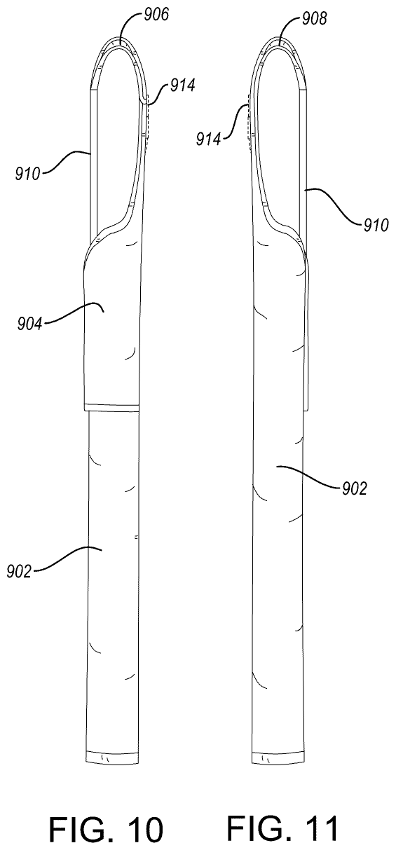

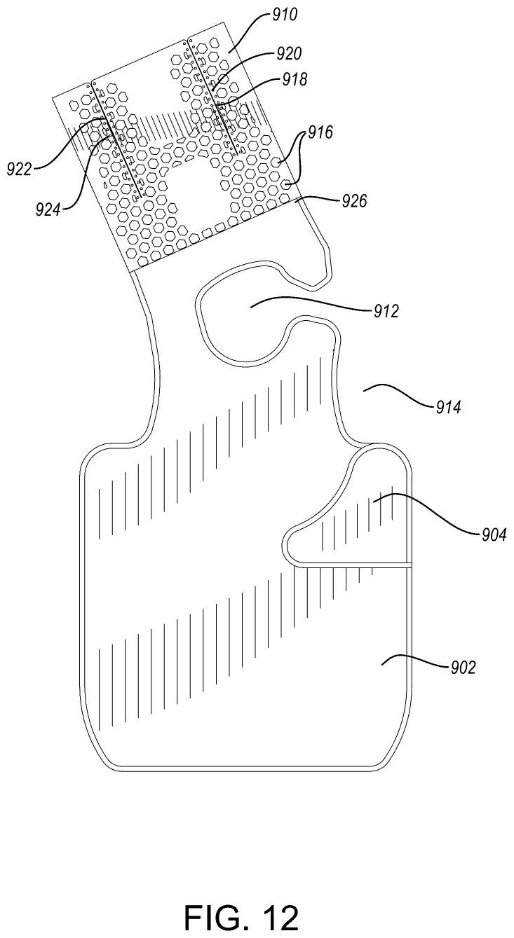

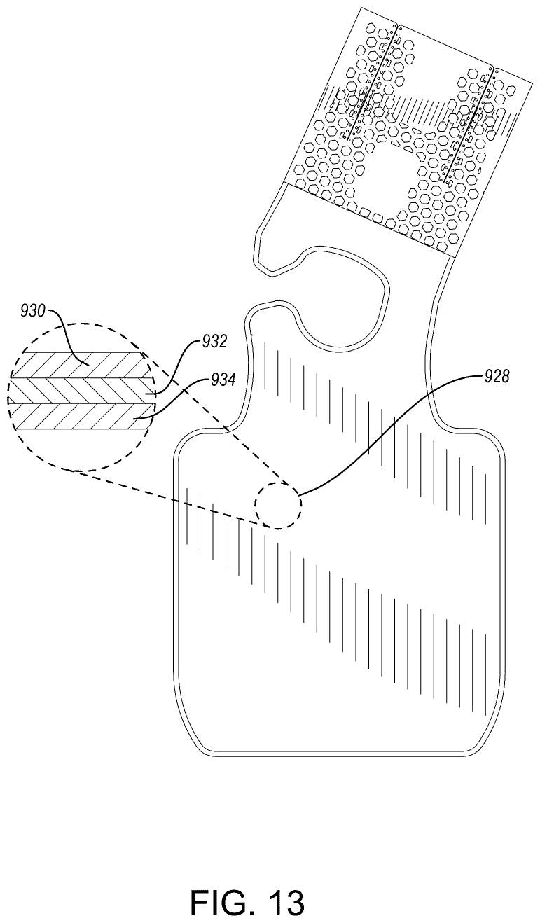

FIG. 9 illustrates a front view of a radiation shielding apparatus configured as a side entry apparatus, according to aspects of the present disclosure. FIG. 10 illustrates a side view of the radiation shielding apparatus of FIG. 9, according to an embodiment. FIG. 11 illustrates a different side view of the radiation shielding apparatus of FIG. 9, according to an embodiment. FIG. 12 illustrates a partially assembled flat view of a first side of the radiation shielding apparatus of FIG. 9 with expandable portions, according to aspects of the present disclosure. FIG. 13 illustrates a partially assembled flat view of an opposite side of the radiation shielding apparatus of FIG. 9 with expandable portions, according to aspects of the present disclosure.

Referring to FIGS. 9-13, a radiation shielding apparatus 900 is configured as a side entry garment with an open back is shown. That is, the user can the garment 900 through the side. The radiation shielding apparatus 900 includes a front portion 902 that provides radiation protection to the torso of a user. An opening portion 904 is positioned along one side of the radiation shielding apparatus 900, enabling side entry access for the user to don and doff the garment. The radiation shielding apparatus 900 includes a left detachable shoulder portion 906 and a right shoulder portion 908, which together provide coverage over the user's shoulders. A neck opening 912 is formed at an upper region of the radiation shielding apparatus 900 to accommodate the user's neck and head. A back portion 910 is visible and configured with an open design to reduce the overall weight of the garment. A side opening mechanism 914 is positioned adjacent to the opening portion 904, facilitating the side entry configuration of the radiation shielding apparatus 900. The side opening mechanism 914 may include a magnetic buckle closure mechanism, although other closure mechanisms may be utilized. In addition, the side opening 904 is a flap positioned to releasably engage an attachment mechanism on the front portion 902 and includes its own attachment mechanism. The attachment mechanism and in include any attachment mechanism described herein, e.g., hook-and-loop, magnets, snaps, combinations of the same and the like.

With continued reference to FIG. 9, the radiation shielding apparatus 900 provides a lightweight design that allows for extended use while maintaining radiation protection for medical professionals working in environments with radiation exposure. The radiation shielding apparatus 900 may be configured for use in Cath labs, Radiology rooms, and health imaging departments. The side entry configuration of the radiation shielding apparatus 900 allows a user to don the garment from the side rather than from the front or back.

FIGS. 10 and 11 illustrate orthogonal views of the radiation shielding apparatus 900. FIG. 10 shows a front view of the radiation shielding apparatus 900, while FIG. 11 shows a side view of the radiation shielding apparatus 900. The radiation shielding apparatus 900 features an elongated form with a rounded upper portion configured to accommodate a user's neck and shoulder region. The radiation shielding apparatus 900 extends downward to provide coverage for the torso area. The open back design of the radiation shielding apparatus 900 contributes to reduced overall weight of the garment while maintaining radiation protection for areas of the body that face toward radiation sources during medical procedures.

Referring now to FIG. 12, the radiation shielding apparatus 900 including a front portion 902, along with the opening portion 904, the open back portion 910, the neck opening 912, and the side opening 914. The back portion 910 features an open design with openings 916 arranged in a hexagonal pattern across an upper region. A first expandable portion 918 is positioned in an upper area of the back portion 910 and includes holes 920 through which an expandable mechanism is configured to be woven. The expand mechanism is described herein, e.g., elastic cord. A second expandable portion 922 is located below the first expandable portion 918 and includes holes 924 that similarly accommodate an expandable mechanism. The first expandable portion 918 and the second expandable portion 922 are configured to expand with pressure, thereby allowing a user to breathe during use and permit movement. A seam 926 extends along a perimeter of the radiation shielding apparatus 900, defining a boundary between the front portion 902 and the back portion 910.

With continued reference to FIG. 12, the open back design of the radiation shielding apparatus 900 reduces the overall weight of the garment while providing attachment points for a detachable back panel when additional radiation protection is desired. The openings 916 arranged in the hexagonal pattern provide breathability and reduce the overall weight of the garment.

Referring to FIG. 13, a magnified section 928 of the radiation shielding apparatus 900 is shown, illustrating a layered construction of the garment material. The magnified section 928 reveals a laminated structure comprising three distinct layers. An outer layer 930 forms an exterior surface of the radiation shielding apparatus 900 and provides protection and aesthetic appearance. A core material 932 is positioned between the outer layer 930 and an inner layer 934, and contains radiation shielding material as described herein configured to attenuate radiation exposure. The inner layer 934 forms an interior surface of the garment that contacts or faces the wearer.

As further shown in FIG. 13, the layered construction enables the radiation shielding apparatus 900 to provide radiation protection while maintaining a wearable garment form. The core material 932 may include a radiation protection vinyl constructed of a high atomic weight element on one layer and a lower atomic weight element on another layer. In some cases, the core material 932 may comprise an edge bilayer material having two distinct homogenous layers as one integral sheet. The magnified section 928 demonstrates how the outer layer 930, the core material 932, and the inner layer 934 are arranged in a sandwich configuration to create the protective structure of the radiation shielding apparatus 900. The combination of the layered construction and the open back design allows the radiation shielding apparatus 900 to provide radiation shielding while reducing garment weight for extended wear during medical procedures.

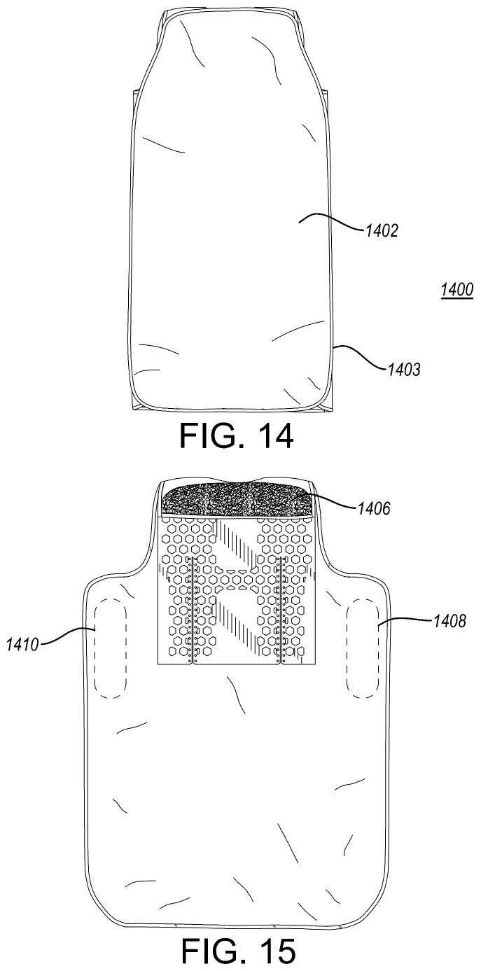

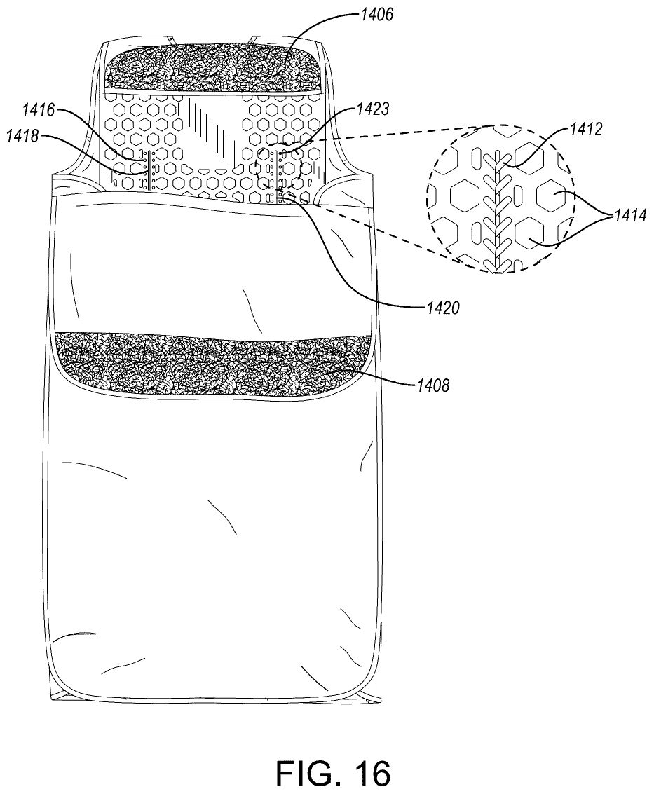

FIG. 14 illustrates a rear view of a radiation shielding apparatus with a detachable back portion, according to aspects of the present disclosure. FIG. 15 illustrates a rear view of the radiation shielding apparatus of FIG. 14 with the detachable back portion removed, according to an embodiment. FIG. 16 illustrates a rear view of the radiation shielding apparatus of FIG. 14 with a partially attached back portion in a first configuration according to aspects of the present disclosure.

Referring to FIGS. 14 and 15, a radiation shielding apparatus 1400 configured as a side entry garment with a cover is shown. The radiation shielding apparatus 1400 includes a detachable back portion 1402, which appears as a rectangular panel with a slightly curved bottom edge. The detachable back portion 1402 is designed to provide radiation protection to the back of a user when attached to a main garment body. The radiation shielding apparatus 1400 includes an upper attachment mechanism 1406, such as a hook-and-loop fastener like Velcro™, positioned near an upper back region of the garment. The upper attachment mechanism 1406 facilitates secure coupling of the detachable back portion 1402 via the attachment mechanism 1408 to the main body of the radiation shielding apparatus 1400.

With continued reference to FIGS. 14 and 15, the radiation shielding apparatus 1400 further includes a lower attachment mechanism 1408 positioned on one side of the back region, and another lower attachment mechanism 1410 positioned on an opposite side. The lower attachment mechanism 1408 and the lower attachment mechanism 1410 are configured as hook-and-loop fasteners, such as Velcro™, and work in conjunction with the upper attachment mechanism 1406 to secure the detachable back portion 1402 via inner attachment mechanisms in place during use. The back of the radiation shielding apparatus 1400 displays a pattern of hexagonal openings in a central region, which provides breathability and reduces the overall weight of the garment. Expandable portions with holes are visible on either side of the hexagonal pattern, featuring elastic cord woven through the openings to allow the garment to expand with user movement and breathing. The back portion is described herein.

Referring to FIG. 16, a front view of the radiation shielding apparatus 1400 with the detachable back portion 1402 in a partially raised position is shown. The upper attachment mechanism 1406 is positioned at a top of the garment for securing the detachable back portion 1402. The lower attachment mechanism 1408 is located at a lower region of the garment. The attachment mechanisms can include a hook-and-loop fastener like Velcro™ provided for securing purposes. The back portion of the radiation shielding apparatus 1400 features openings 1414 arranged in a hexagonal pattern across an upper region.

As further shown in FIG. 16, the back portion includes a first expandable section 1420 and a holes 1423 for securing an expandable member 1412. In this embodiment, the expandable member 1412 is an elastic cord woven through the openings 1423, which allows the back portion to expand with pressure and accommodate user breathing. The radiation shielding apparatus 1400 includes a second expandable portion 1418 positioned and a plurality of holes 1416. The second expandable portion 1418 also include an elastic member woven through the openings 1416. The first expandable portion 1420 and the second expandable portion 1418 are configured to provide flexibility and breathability to the garment while maintaining radiation protection. The expandable mechanisms woven through the openings and the holes of accommodates movement and breathing of a user during extended wear by allowing the garment to expand and retract.

With continued reference to FIG. 16, the radiation shielding apparatus 1400 is configured to block and/or attenuate both primary radiation coming directly from a source, such as a C-arm emission of an X-ray tube, and scattered radiation resulting from interactions with matter such as body tissue.

In this embodiment, the radiation shielding cover 1400 is formed from a single-piece laminated material comprising an outer layer, an inner layer, and a radiation shielding core material encapsulated therebetween. The laminated material is joined only along a peripheral seam 1403 extending around an outer edge of the laminate, such that the peripheral seam secures and contains the radiation shielding core material to prevent shifting or redistribution of the core material during use. By confining seams, stitching, or other attachment techniques to the peripheral edge region, the laminated structure maintains a continuous, uninterrupted radiation shielding area and minimizes or eliminates radiation and scatter-radiation leakage paths that could otherwise result from internal seams, perforations, or core displacement. The core material of the radiation shielding apparatus 1400 may include radiation shielding material comprising specially graded metal particles distributed evenly within a vinyl matrix of each layer. The open back design with the expandable mechanism 1414 reduces the overall weight of the radiation shielding apparatus 1400 while allowing for comfortable extended wear during medical procedures. The detachable back portion 1402 may be attached or removed based on radiation exposure requirements of a particular procedure, enabling the wearer to customize the level of back protection.

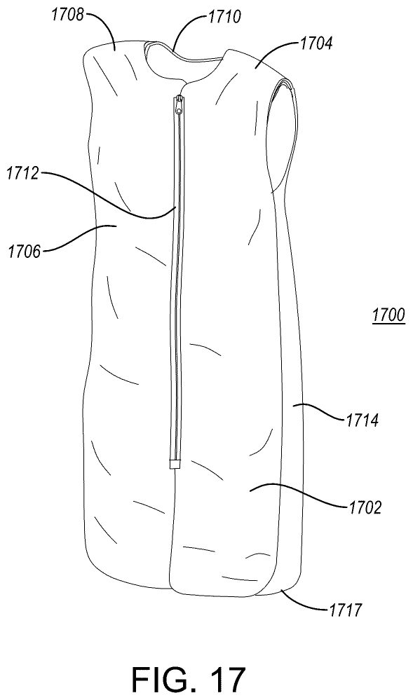

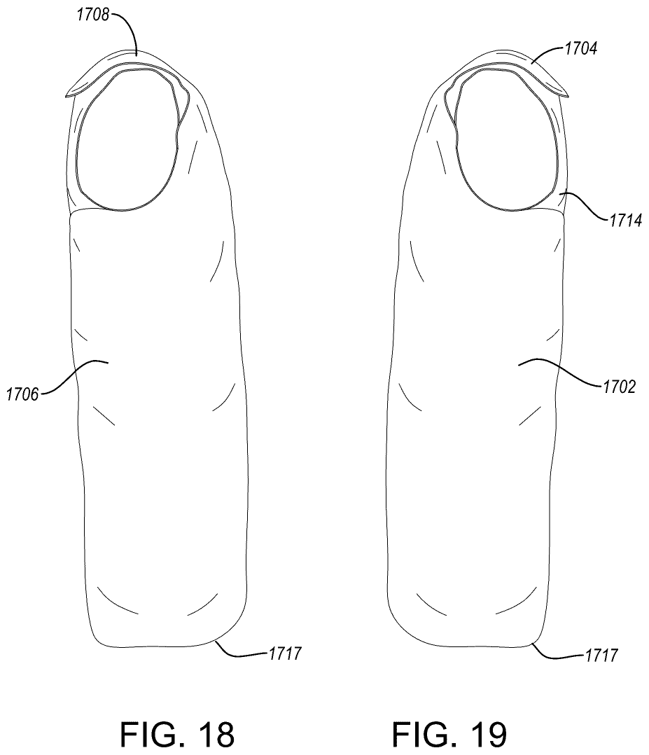

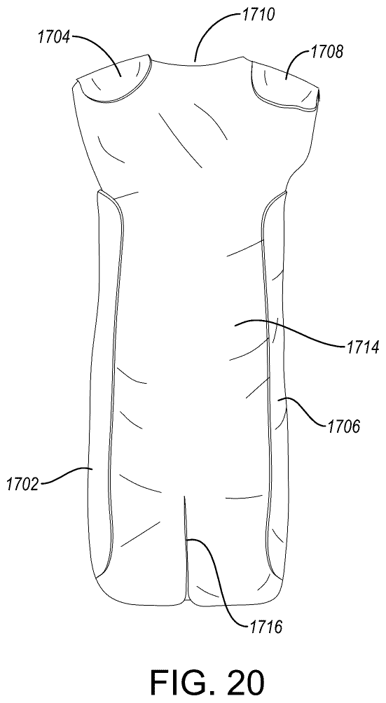

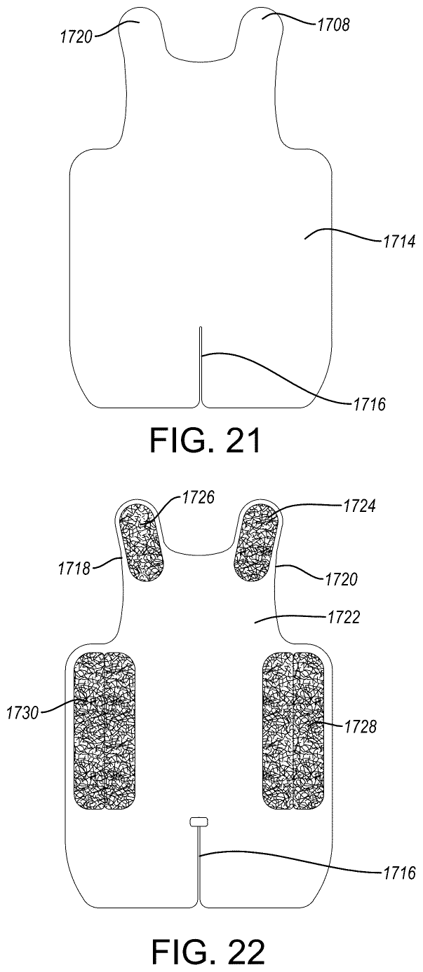

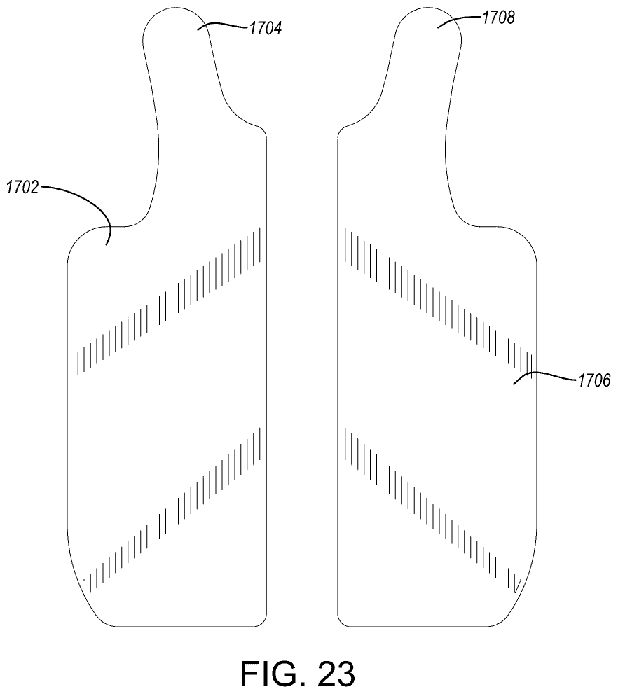

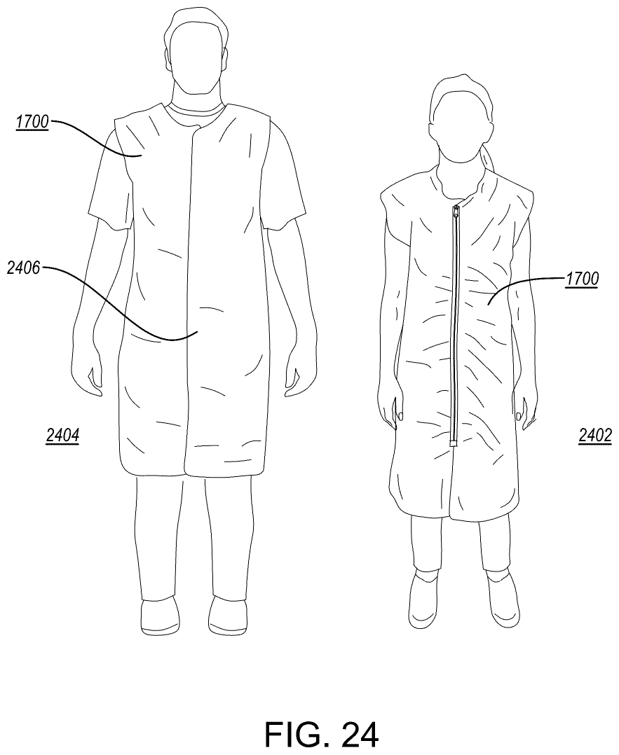

FIG. 17 illustrates a side view of a radiation shielding apparatus configured to accommodate different sized users, according to aspects of the present disclosure. FIG. 18 illustrates a side view of the radiation shielding apparatus of FIG. 17, according to an embodiment. FIG. 19 illustrates a different side view of the radiation shielding apparatus of FIG. 17, according to an embodiment. FIG. 20 illustrates a rear view of the radiation shielding apparatus of FIG. 17 with an adjustable opening, according to aspects of the present disclosure. FIG. 21 illustrates an unassembled outside view of a rear panel for the radiation shielding apparatus of FIG. 17, according to an embodiment. FIG. 22 illustrates an unassembled inside view of a rear panel for the radiation shielding apparatus of FIG. 17, according to an embodiment. FIG. 23 illustrates unassembled front panels for the radiation shielding apparatus of the radiation shielding apparatus of FIG. 17 in a flat configuration, according to aspects of the present disclosure. FIG. 24 illustrates front views of the radiation shielding apparatus of FIG. 17 arranged on persons of different heights, according to an embodiment.

Referring to FIGS. 17-24, is configured to be universal for different people is shown. This garment is unisex, universally fitted garment is designed to suit a wide range of body types. Includes a front zipper, side and shoulder hook-and-loop panels, and a reinforced pocket. Paired with or without the endoskeleton, this apron offers healthcare professionals a versatile, easy-to-fit option that eliminates the need for precise sizing. The radiation shielding apparatus 1700 includes a left front portion 1702 and a right front portion 1706, which together form the front body coverage of the garment. The radiation shielding apparatus 1700 further includes a left shoulder portion 1704 and a right shoulder portion 1708, which extend from the respective front portions to provide coverage over the shoulders of a wearer. A neck opening 1710 is positioned at an upper region of the radiation shielding apparatus 1700, allowing the wearer's head to pass through when donning the garment. A closing mechanism 1712, such as a zipper, extends vertically along the front of the radiation shielding apparatus 1700, enabling the wearer to open and close the garment for ease of entry and secure fit during use. Of course other closing mechanism may be utilized as described herein, e.g., hook-and-loop, magnets, snaps, and combinations of the same and the like.

An outside rear panel 1714 is visible and provides radiation shielding coverage to the back region of the wearer. An adjustable opening 1716 is located at a lower portion of the radiation shielding apparatus 1700. A bottom portion 1717 defines the lower edge of the radiation shielding apparatus 1700.

With continued reference to FIG. 17, the radiation shielding apparatus 1700 is configured as a sleeveless garment that provides radiation protection to the torso while allowing freedom of movement for the arms. The garment is configured to enable the radiation shielding apparatus 1700 to function as a one size fits all garment that allows for use by individuals ranging in height from approximately 5′2″ to approximately 6′5″ or greater.

Referring to FIGS. 18 and 19, front orthogonal views of the radiation shielding apparatus 1700 are shown. The left front portion 1702 and the right front portion 1706 together form the front coverage area of the garment. The left shoulder portion 1704 extends from an upper region of the left front portion 1702, while the right shoulder portion 1708 extends from an upper region of the right front portion 1706. The left shoulder portion 1704 and the right shoulder portion 1708 are configured to rest on the shoulders of a user and provide radiation shielding coverage to the upper torso area. The outside rear panel 1714 is visible extending from behind the front portions of the garment, providing additional radiation protection to the back region of the user. The shoulder portions 1708 and 1704 are adjustable allowing the garment to be used by different height and weight individuals. The shoulder portions 1708 and 1704 have attachment mechanism on the inter side to allow for reliably attaching the garment and moving different heights. The left front portion 1702 and the right front portion 1706 also have attachment mechanisms as described herein to allow releasably attaching to different widths to accommodate different sized individuals.

Referring to FIG. 20, a front view of the radiation shielding apparatus 1700 is shown. The left front portion 1702, the right front portion 1706, the left shoulder portion 1704, and the right shoulder portion 1708 are visible. The attachment mechanism under the left front portion 1702, the right front portion 1706, the left shoulder portion 1704, and the right shoulder portion 1708 allow for releasably attaching and sizing of the garment. In a preferred embodiment, the attachment mechanisms is a hook-and-loop attachment mechanism. The neck opening 1710 is positioned at the top of the garment between the left shoulder portion 1704 and the right shoulder portion 1708. The outside rear panel 1714 is visible extending along the back of the garment. The opening 1716 is located at the lower portion of the garment, further enabling the radiation shielding apparatus 1700 to accommodate wearers of varying heights and body sizes and allow for movement of the user.

Referring to FIGS. 21 and 22, the outside rear panel 1714 in a flat configuration is shown. The outside rear panel 1714 includes the adjustable opening 1716 at a bottom portion and an attachment mechanisms 1718, 1724, 1728 and 1730, such as a hook-and-loop fastener like Velcro™, positioned along an upper region of the panel and side region of the panel. These attachment mechanisms are configured to correspond to attachment mechanisms on panels 1702 and 1706. The attachment mechanisms 1718, 1724, 1728 and 1730 allow for adjustability of height and weight of user.

In addition, each of the panels 1702, 1706, 1714, and 1722 have a laminated structured as described herein. For clarity, the radiation shielding apparatus is formed from a single-piece laminated material comprising an outer layer, an inner layer, and a radiation shielding core material arranged or encapsulated therebetween. The laminated material is joined only along a peripheral seam extending around an outer edge of the laminate, such that the peripheral seam secures and contains the radiation shielding core material to prevent shifting or redistribution of the core material during use. By confining seams, stitching, or other attachment techniques to the peripheral edge region, the laminated structure maintains a continuous, uninterrupted radiation shielding area and minimizes or eliminates radiation and scatter-radiation leakage paths that could otherwise result from internal seams, perforations, or core displacement

As further shown in FIGS. 21 and 22, a side radiation shielding region 1726 is positioned on either side of an upper portion of the inside rear panel 1722, providing radiation protection to side body areas of a user. The inside rear panel 1722 further includes an attachment mechanism 1728, such as a hook-and-loop fastener like Velcro™, positioned on a lower right portion and an attachment mechanism 1730, such as a hook-and-loop fastener like Velcro™, positioned on a lower left portion. The adjustable opening 1716 is also visible at the bottom of the inside rear panel 1722. The arrangement of the attachment mechanism 1718, the attachment mechanism 1724, the attachment mechanism 1728, and the attachment mechanism 1730 enables the outside rear panel 1714 and the inside rear panel 1722 to be secured together and attached to the radiation shielding apparatus 1700. The side radiation shielding region 1726 extends the radiation protection coverage beyond a central back area to include portions of the user's sides.

Referring to FIG. 23, a front view of the radiation shielding apparatus 1700 in a flat, unfolded configuration is shown. The left front portion 1702 and the right front portion 1706 are positioned adjacent to one another. The left shoulder portion 1704 extends upward from an upper region of the left front portion 1702, and the right shoulder portion 1708 extends upward from an upper region of the right front portion 1706. Lower regions of both the left front portion 1702 and the right front portion 1706 feature a textured area. A central opening is formed between the left front portion 1702 and the right front portion 1706, which provides the adjustable opening 1716 for accommodating users of varying sizes.

Referring to FIG. 24, front views of the radiation shielding apparatus 1700 arranged on persons of different sizes are shown, demonstrating the universal fit capability of the garment. On a left side of FIG. 24, a radiation shielding apparatus arranged on second sized person taller than first sized person 2404 shows the garment worn by a taller individual, e.g., 6 ft or taller. A closing portion 2406 is visible on the left side of the garment, indicating a closure mechanism location, e.g., hook-and-loop closing mechanism. On a right side of FIG. 24, a radiation shielding apparatus arranged on first sized person 2402 shows the radiation shielding apparatus 1700 worn by a shorter individual, e.g., 5 ft 2 inches or less in height. The radiation shielding apparatus 1700 features the closing mechanism 1719 running down the center front of the garment, e.g., a zipper.

With continued reference to FIG. 24, both views demonstrate how the radiation shielding apparatus 1700 is universal and configured to accommodate users of varying heights and weights, with the garment extending to cover the torso and upper leg regions of both individuals. The slit 1716 permits easy movement of the legs by allowing more movement of the garment. Again, the universal sizing capability allows a single garment design to fit individuals ranging in height from approximately 5′2″ or even shorter to approximately 6′5″ or greater while maintaining appropriate coverage for radiation shielding purposes during medical procedures. The adjustments of the panel system enable the radiation shielding apparatus 1700 to accommodate users of varying heights and body types without requiring multiple garment sizes.

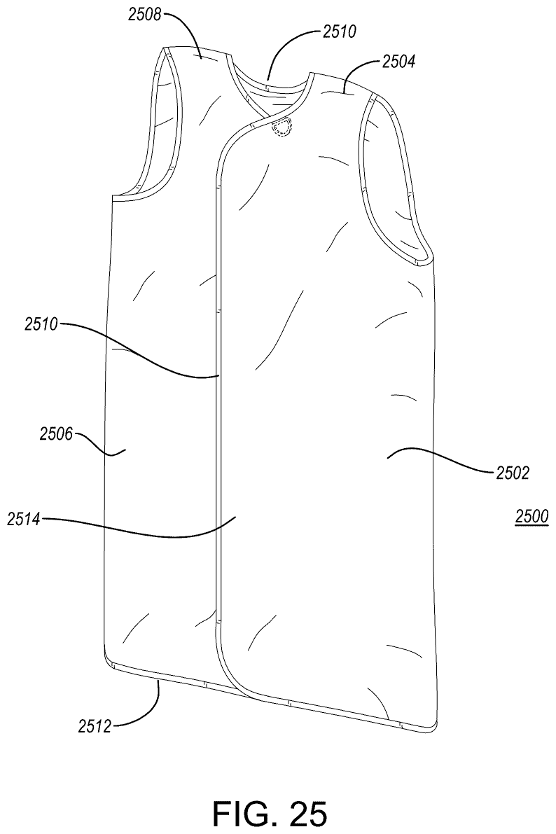

Referring to FIG. 25, a radiation shielding apparatus 2500 is shown. The radiation shielding apparatus 2500 is configured as a single piece of material in a vest-style garment designed to protect a user from radiation exposure. The radiation shielding apparatus 2500 includes a left front portion 2502 and a right front portion 2506, which together form the front coverage area of the garment. A left shoulder portion 2504 and a right shoulder portion 2508 extend from upper regions of the respective front portions to provide coverage over the shoulders of the wearer. The left shoulder portion 2504 and the right shoulder portion 2508 define openings for the arms of the user.

Again, the radiation shielding apparatus is formed from a single-piece laminated material comprising an outer layer, an inner layer, and a radiation shielding core material encapsulated therebetween. The laminated material is joined only along a peripheral seam 2510 extending around an outer edge of the laminate, such that the peripheral seam secures and contains the radiation shielding core material to prevent shifting or redistribution of the core material during use. By confining seams, stitching, or other attachment techniques to the peripheral edge region, the laminated structure maintains a continuous, uninterrupted radiation shielding area and minimizes or eliminates radiation and scatter-radiation leakage paths that could otherwise result from internal seams, perforations, or core displacement

The seam 2510 is visible along an upper edge of the garment, extending around a neck opening and shoulder regions, providing structural integrity to the radiation shielding apparatus 2500. The radiation shielding apparatus 2500 includes a bottom portion 2512 that extends downward to provide coverage to the lower torso of the wearer. A front closure mechanism 2514 is positioned along a left side of the garment, extending vertically from an upper region toward the bottom portion 2512, enabling the wearer to open and close the radiation shielding apparatus 2500 for donning and doffing.

With continued reference to FIG. 25, the radiation shielding apparatus 2500 is depicted with a sleeveless design, allowing for freedom of arm movement during use in medical procedures or other environments where radiation protection is desired. The front closure mechanism 2514 may comprise a zipper, although other closure mechanisms such as snaps, hook and loop fasteners, magnets, or combinations thereof may be utilized. The radiation shielding apparatus 2500 may be configured for use with a shoulder transfer weight support system that transfers weight from shoulders to hips of a user. The radiation shielding apparatus 2500 may include interior belt loops that complement shoulder and waist portions of a weight supporting device. Components of the weight supporting device, such as mantis bars or shoulder bars, may be slid through the interior belt loops of the radiation shielding apparatus 2500 to integrate the weight supporting device with the radiation shielding apparatus 2500.

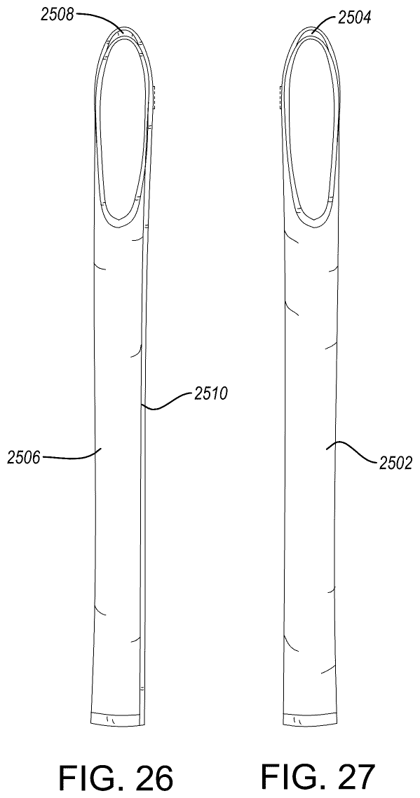

FIGS. 26 and 27 illustrate front orthogonal views of the radiation shielding apparatus 2500. The radiation shielding apparatus 2500 is shown in two slightly different orientations to demonstrate an elongated form factor. The radiation shielding apparatus 2500 features an elongated body with a rounded loop portion at an upper end and a tapered lower end. The loop portion at the top of the radiation shielding apparatus 2500 forms an oval-shaped opening. The body of the radiation shielding apparatus 2500 extends downward from the loop portion in a generally straight configuration with subtle contour lines indicating a three-dimensional form of the apparatus. A lower portion of the radiation shielding apparatus 2500 terminates in an angled edge.

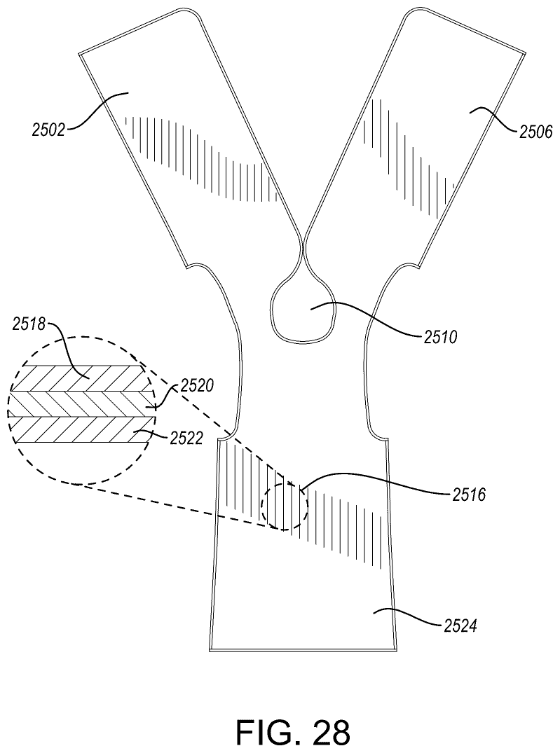

Referring to FIG. 28, a front view of the radiation shielding apparatus 2500 with a magnified region 2516 showing a layered construction of the garment is shown. The left front portion 2502 and the right front portion 2506 are configured to cover a user's torso. The left front portion 2502 and the right front portion 2506 are joined together at the seam 2510 located at a center front of the garment. A back panel portion 2524 extends from a lower section of the radiation shielding apparatus 2500. The magnified region 2516 provides a detailed cross-sectional view of the layered structure of the radiation shielding apparatus 2500.

As further shown in FIG. 28, the layered structure includes an outer layer 2518, a core material 2520, and an inner layer 2522. The core material 2520 is arranged between the outer layer 2518 and the inner layer 2522. The outer layer 2518 forms an exterior surface of the garment, while the inner layer 2522 is positioned adjacent to the user's body when worn. The core material 2520 comprises radiation shielding material, as described herein, and configured to protect the user from radiation exposure. The laminated construction provides radiation protection while maintaining structural integrity of the radiation shielding apparatus 2500.

With continued reference to FIG. 28, the radiation shielding apparatus 2500 may include complementary attachment mechanisms such as snaps, buttons, or magnets to secure a weight supporting device to the radiation shielding apparatus 2500. The radiation shielding apparatus 2500 may include a plurality of hook-and-loop fasteners configured to enable attachment of accessories including undergarments, weight supporting device components, padding, cushions, and labels. The weight supporting device may include a waist portion with opposing ends coupled by a hook-and-loop fastener configured to encircle a user's waist and/or hips. In some cases, the waist portion of the weight supporting device may include a buckle in addition to the hook-and-loop fastener for further securing the weight supporting device to the user. The weight supporting device may include one or more straps configured to stabilize a shoulder portion of the weight supporting device during use and adjust to users of varying sizes.

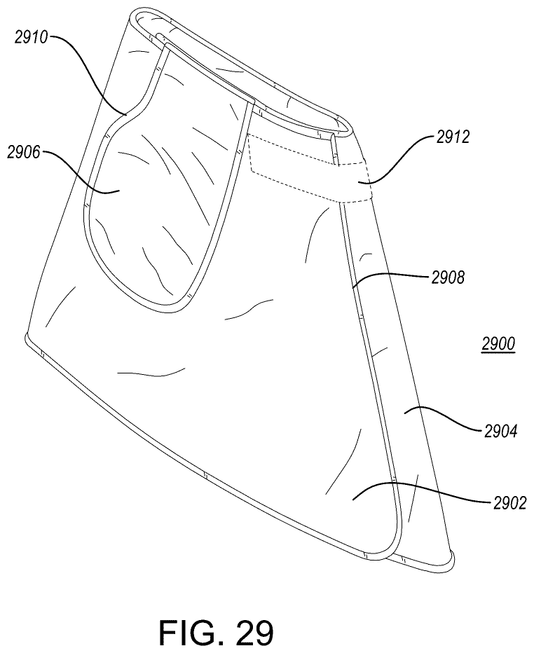

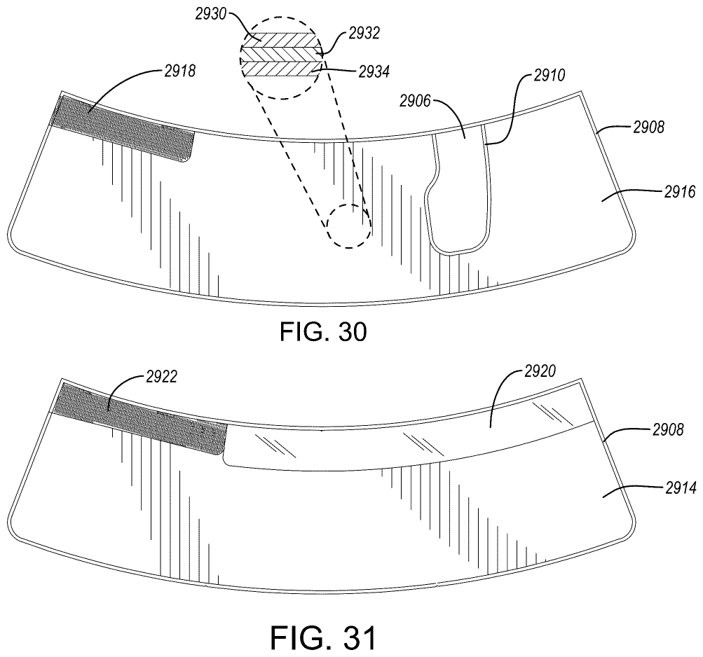

FIG. 29 illustrates an perspective view of a radiation shielding apparatus configured as a skirt, according to aspects of the present disclosure. FIG. 30 illustrates a partially assembled flat view of a first side of the radiation shielding apparatus of FIG. 30 with expandable portions, according to aspects of the present disclosure. FIG. 31 illustrates a partially assembled flat view of a first side of the radiation shielding apparatus of FIG. 30 with expandable portions, according to aspects of the present disclosure.

Referring to FIGS. 29-31, a radiation shielding apparatus, e.g., skirt 2900 is shown. The apparatus 2900 is configured to protect a user's lower extremities and made from a single-piece of laminated material. The skirt 2900 includes a front portion 2902 and a rear portion 2904. A pocket 2906 is positioned on the front portion 2902, providing storage capability for the wearer.

The apparatus 2900 further includes a seam 2910 visible along a peripheral region of the radiation shielding apparatus. The apparatus 2900 has opposing ends configured to be at least partially coupled by a buckle and hook-and-loop fasteners and/or a closure mechanism 2912, e.g., a buckle, although other closure mechanisms such as snaps, zippers, magnets, hook and loop fasteners, or combinations thereof may be utilized. The apparatus 2900 is configured to provide radiation protection to the lower extremities of a user during medical procedures or other environments where radiation exposure may occur.

Referring to FIGS. 30 and 31, an inside and outside of the panel is shown. The apparatus 2900 is formed from a single-piece laminated material comprising an outer layer 2930, an inner layer 2934, and a radiation shielding core material 2932 encapsulated therebetween. Each of these layers is described herein. The laminated material is joined only along a peripheral seam 2908 extending around an outer edge of the laminate, such that the peripheral seam 2908 secures and contains the radiation shielding core material to prevent shifting or redistribution of the core material during use. By confining seams, stitching, or other attachment techniques to the peripheral edge region, the laminated structure maintains a continuous, uninterrupted radiation shielding area and minimizes or eliminates radiation and scatter-radiation leakage paths that could otherwise result from internal seams, perforations, or core displacement

Panel in FIG. 30, includes a pocket 2906 and seam located on panel. An attachment mechanism 2918, e.g., hook-and-loop, Velcro™, is positioned near the upper edge to to facilitate connection of the rear panel attachment mechanism 2914. The attachment mechanisms 2918 and 2922 can be any attachment mechanism described herein. In addition, a grip material 2920 is provided on the panel. The grip material can be [add material].

The foregoing description of the embodiments has been presented for purposes of illustration and description and is not intended to be exhaustive or to limit the disclosure to the precise forms disclosed. Modifications, substitutions, and variations will be apparent to those of ordinary skill in the art in light of the above teachings. The embodiments were selected and described in order to best explain the principles of the disclosure and its practical application, thereby enabling others skilled in the art to utilize the disclosure in various embodiments and with various modifications as may be suited to a particular use or implementation.

It is intended that the scope of the disclosure be defined by the appended claims and their equivalents, rather than by the foregoing description. The claims are to be interpreted broadly in light of the specification and drawings, consistent with the understanding of one of ordinary skill in the art. Accordingly, limitations described in connection with particular embodiments should not be read into the claims unless expressly recited therein.

Features, elements, steps, or aspects described in connection with one embodiment may be combined with, substituted for, or omitted from features of other embodiments, even if not expressly described in such combinations, provided such combinations are not inconsistent or mutually exclusive. Similarly, features described as optional, alternative, or exemplary in one embodiment may be included or excluded in other embodiments.

Unless the context clearly indicates otherwise, the terms “comprise,” “comprising,” “include,” and “including” are to be construed as open-ended and inclusive, meaning “including but not limited to.” The use of ordinal terms such as “first,” “second,” and the like are for convenience only and do not imply any particular order, sequence, or priority unless explicitly stated.

References to structural components, materials, processes, or acts are intended to encompass not only the specifically disclosed embodiments but also functional equivalents thereof that perform substantially the same function, in substantially the same way, to achieve substantially the same result. Accordingly, known or later-developed equivalents are intended to fall within the scope of the appended claims.

1. A radiation shielding garment, comprising:
a single laminated piece configured to cover a torso of a user, the single laminated piece having no seams to prevent radiation leakage therethrough, the single laminated piece including:
an outer layer forming an exterior surface of the garment;
an inner layer forming an interior surface of the garment; and
a core material arranged between the outer layer and the inner layer, the core material comprising a radiation shielding material configured to attenuate radiation;
a back portion connected to the single laminated piece, the back portion including a plurality of openings arranged in a pattern; and
at least one expandable portion positioned in the back portion, the at least one expandable portion having a plurality of holes and an expandable mechanism extending through the plurality of holes, the expandable mechanism configured to expand with pressure applied by the user.

2. The radiation shielding garment of claim 1, wherein the core material includes one or more of a light lead radiation shielding material, a lead radiation shielding material, and a lead free radiation shielding material configured to have a lead equivalence in a range from about 0.125 mm to about 1.0 mm.

3. The radiation shielding garment of claim 2, wherein the core material comprises a radiation protection vinyl constructed of a high atomic weight element on one layer and a lower atomic weight element on another layer.

4. The radiation shielding garment of claim 3, wherein the core material comprises an edge bilayer material having two distinct homogenous layers as one integral sheet with specially graded metal particles distributed evenly within a vinyl matrix of each layer.

5. The radiation shielding garment of claim 1, wherein the core material comprises a composition including emulsion polymers, plasticizers, finely divided lead and lead-free particles, stabilizers, and pigments.

6. A radiation shielding apparatus, comprising:
a front portion configured to cover a torso of a user, the front portion including a radiation shielding material configured to attenuate radiation;
a back portion connected to the front portion, the back portion including:
a plurality of openings arranged in a pattern;
at least one expandable portion having a plurality of holes; and
an expandable mechanism extending through the plurality of holes, the expandable mechanism configured to expand with pressure applied by the user; and
a detachable back panel configured to removably attach to the back portion, the detachable back panel comprising a laminated structure having three layers including an outer layer, an inner layer, and a core material arranged between the outer layer and the inner layer, the core material comprising a radiation shielding material.

7. The radiation shielding apparatus of claim 6, wherein the core material of the detachable back panel includes one or more of a light lead radiation shielding material, a lead radiation shielding material, and a lead free radiation shielding material configured to have a lead equivalence in a range from about 0.125 mm to about 1.0 mm.

8. The radiation shielding apparatus of claim 6, further comprising at least one attachment mechanism configured to secure the detachable back panel to the back portion, the at least one attachment mechanism including a hook-and-loop fastener.

9. The radiation shielding apparatus of claim 8, wherein the at least one attachment mechanism includes:
an upper attachment mechanism positioned at an upper region of the back portion;
a first lower attachment mechanism positioned at a first lower region of the back portion; and
a second lower attachment mechanism positioned at a second lower region of the back portion.

10. The radiation shielding apparatus of claim 6, wherein the detachable back panel extends past a bottom of the back portion to cover a portion of legs of the user.

11. A radiation shielding apparatus, comprising:
a front portion configured to cover a torso of a user, the front portion including a radiation shielding material configured to attenuate radiation;
a back portion connected to the front portion, the back portion including:
a plurality of openings arranged in a pattern;
at least one expandable portion having a plurality of holes; and
an expandable mechanism extending through the plurality of holes, the expandable mechanism configured to expand with pressure applied by the user; and
a side opening positioned along a side of the radiation shielding apparatus, the side opening configured to allow the user to don and doff the radiation shielding apparatus from a side of the user.

12. The radiation shielding apparatus of claim 11, wherein the plurality of openings are hexagonal openings.

13. The radiation shielding apparatus of claim 11, wherein the expandable mechanism is an elastic cord woven through the plurality of holes.

14. The radiation shielding apparatus of claim 11, further comprising a detachable back panel configured to removably attach to the back portion, the detachable back panel including radiation shielding material.

15. The radiation shielding apparatus of claim 14, further comprising at least one attachment mechanism configured to secure the detachable back panel to the back portion, the at least one attachment mechanism including:
an upper attachment mechanism positioned at an upper region of the back portion;
a first lower attachment mechanism positioned at a first lower region of the back portion; and
a second lower attachment mechanism positioned at a second lower region of the back portion.

16. A radiation shielding garment, comprising:
a single laminated piece configured to cover a torso of a user, the single laminated piece including:
an outer layer forming an exterior surface of the garment;
an inner layer forming an interior surface of the garment; and
a core material arranged between the outer layer and the inner layer, the core material comprising a radiation shielding material configured to attenuate radiation;
a left front portion and a right front portion forming a front coverage area of the garment;
a left shoulder portion connected to the left front portion and a right shoulder portion connected to the right front portion;
an outside rear panel connected to the front coverage area, the outside rear panel including an adjustable opening configured to accommodate users ranging in height from approximately 5 feet to approximately 6 feet or greater;
an inside rear panel configured to attach to the outside rear panel, the inside rear panel including side radiation shielding regions configured to protect side body areas of the user; and
a closing mechanism configured to secure the garment around the user.

17. The radiation shielding garment of claim 16, wherein the core material includes one or more of a light lead radiation shielding material, a lead radiation shielding material, and a lead free radiation shielding material configured to have a lead equivalence in a range from about 0.125 mm to about 1.0 mm.

18. The radiation shielding garment of claim 17, wherein the core material comprises a radiation protection vinyl constructed of a high atomic weight element on one layer and a lower atomic weight element on another layer.

19. The radiation shielding garment of claim 16, further comprising a plurality of attachment mechanisms configured to secure the inside rear panel to the outside rear panel, the plurality of attachment mechanisms including hook-and-loop fasteners.

20. The radiation shielding garment of claim 16, wherein the closing mechanism includes a zipper extending vertically along a front of the garment.

21.-41. (canceled)
